(19) United States
(12) Patent Application Publication
(10) Pub. No.: US 2026/0212251 A1
(43) Pub. Date: Jul. 23, 2026

(54) QUANTUM PROCESSING DEVICE AND METHOD

(71) Applicant: Diraq Pty Ltd, Elizabeth Bay (AU)

(72) Inventors: Andrew Steven DZURAK, Elizabeth Bay (AU); Andre Luiz SARAIVA DE OLIVEIRA, Bondi Junction (AU); Juan Pablo BONILLA ATAIDES, Rooty Hill (AU); Ensar VAHAPOGLU, Kingsford (AU)

(21) Appl. No.: 19/142,587

(22) PCT Filed: Dec. 22, 2023
(86) PCT No.: PCT/AU2023/051365

§ 371 Date: Jun. 23, 2025

(30) Foreign Application Priority Data
Dec. 23, 2022 (AU) 2022904005

(51) Int. Cl. G06N 10/70; G06N 10/20; G06N 10/40

(52) U.S. Cl. CPC G06N 10/70; G06N 10/20; G06N 10/40

(57) ABSTRACT

A quantum processing device comprising at least one bilinear array of quantum dots, each array being configured to hold a plurality of spin qubits. The device further comprises a controller configured to control the coherent transportation of one or more of the plurality of qubits within each array to implement a quantum error correction code (QECC), wherein the QECC encodes the collective state of the spin qubits of the respective array as a corresponding first-level (L1) logical qubit.

The present application claims priority from Australian Provisional Patent Application No. 2022904005 filed on 23 Dec. 2022, the contents of which are incorporated herein by reference in their entirety.

### TECHNICAL FIELD

This disclosure relates to a quantum processing device and a method for operating a quantum processing device to achieve fault tolerant computation via quantum error correction that is scalable and realizable in current quantum technology.

### BACKGROUND

The realization of a large-scale quantum computer, capable of executing ground breaking algorithms, remains a formidable endeavor because its building blocks—the qubits—are susceptible to errors resulting from effects such as decoherence and from noise. Quantum error correction is used in quantum computing to protect quantum information from errors and is considered to be essential to achieve fault-tolerant quantum computation.

Quantum error correction operates by representing the quantum information associated with a high-quality logical qubit as an entangled state of multiple physical qubits. The state of the physical qubits can therefore be encoded in the logical qubit state. The state of the logical qubit may be protected against errors in one or more of the physical qubits if the logical qubit is encoded according to a quantum error correction code (QECC).

Similar to classical error correction, although QECCs do not always correctly decode logical qubits, their use reduces the effect of noise thereby improving the utility of a quantum processing device. The number of high-fidelity qubits needed for error correction has long remained out of experimental reach. As we enter the era of quantum computing characterized by control over noisy qubits, implementations of quantum error correction are becoming practically realizable. As such, there is demand for error-correction techniques which utilize a small number of qubits and that also consider the constraints of a realistic and manufacturable architecture.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

There is provided a quantum processing device comprising: at least one bilinear array of quantum dots, each array being configured to hold a plurality of spin qubits; and a controller configured to control the coherent transportation of one or more of the plurality of qubits within each array to implement a quantum error correction code (QECC), wherein the QECC encodes the collective state of the spin qubits of the respective array as a corresponding first-level (L1) logical qubit.

In some embodiments, each bilinear array comprises: a first line of N quantum dots configured to hold at most N spin qubits; and a second line of N quantum dots configured to enable entangling operations to be performed between respective qubits via the coherent transportation.

In some embodiments, the spin qubits are held in the first line of the array according to an arrangement that is selected to facilitate the coherent transportation of the one or more of the plurality of spin qubits for performing error correction according to the QECC.

In some embodiments, the device is configured to perform a cycle of the error correction on the L1 logical qubit of any one of the at least one bilinear array by: (i) initializing one or more ancilla qubits of the QECC in the array according to the arrangement; (ii) performing one or more 2-qubit entangling gates, each gate entangling one or more pairs of spin qubits of the QECC; and (iii) measuring the ancilla qubits.

In some embodiments, the entangled qubits of the QECC comprise a data qubit associated with a stabilizer of the QECC and one or more corresponding ancilla qubits of the QECC.

In some embodiments, the device is configured to entangle two spin qubits in the array by coherently transporting a selected spin qubit of the pair of spin qubits from the first line of the array through the second line of the array, aligning the selected spin qubit with the other spin qubit, performing a 2-qubit gate, and then coherently transporting at least the selected spin qubit back to the first line of the array.

In some embodiments, the device is configured to entangle two spin qubits in the array by, if the qubits to be entangled already reside in neighbouring dots, causing a direct local interaction between the qubits.

In some embodiments, the one or more 2-qubit entangling gates are scheduled according to the QECC and the geometry of the bilinear array.

In some embodiments, the arrangement of the qubits in the first line of the array is determined to minimize the depth of the syndrome extraction circuit.

In some embodiments, each bilinear array is comprised of silicon metal-oxide semiconductor (SiMOS) quantum dots.

In some embodiments, the QECC is a surface code.

There is also provided a method for enabling quantum error correction on a quantum processing device, the method comprising: (i) arranging, according to a quantum error correction code (QECC), a plurality of spin qubits in a bilinear array of quantum dots of the quantum processing device, wherein the collective state of a subset of the spin qubits forms a first-level (L1) logical qubit protected by the QECC; (ii) determining a sequence of one or more entangling operations on respective pairs of the plurality of spin qubits; (iii) executing a syndrome extraction circuit to determine a syndrome of the QECC for performing a cycle of error correction by performing the sequence of entangling operations, wherein performing the sequence of entangling operations involves coherently transporting one or more of the plurality of spin qubits within the array.

In some embodiments, the arrangement of the plurality of spin qubits in the first line is selected to facilitate the coherent transportation of the one or more of the plurality of spin qubits for performing error correction according to the QECC.

In some embodiments, executing the syndrome extraction circuit comprises: (i) initializing one or more ancilla qubits of the QECC in the array according to the arrangement; (ii) performing the determined sequence of entangling operations, each entangling operation entangling a pair of spin qubits of the QECC; and (iii) measuring the ancilla qubits.

In some embodiments, each pair of entangled qubits comprises a data qubit associated with a stabilizer of the QECC and one or more corresponding ancilla qubits of the QECC.

In some embodiments, entangling a pair of spin qubits of the QECC comprises: coherently transporting a selected spin qubit of the pair of spin qubits from the first line of the array through the second line of the array, aligning the selected spin qubit with the other spin qubit of the pair, performing a 2-qubit gate, and then coherently transporting at least the selected spin qubit back to the first line of the array.

In some embodiments, entangling a pair of spin qubits comprises: if the qubits to be entangled already reside in neighbouring dots, causing a direct local interaction between the qubits without coherently transporting either of the qubits.

In some embodiments, the sequence of entangling operations of the syndrome extraction circuit is determined according to the QECC and the geometry of the bilinear array.

In some embodiments, the arrangement of the qubits in the first line of the array is determined to minimize the depth of the syndrome extraction circuit.

In some embodiments, the method for enabling quantum error correction on a quantum processing device further comprises: (iv) decoding the syndrome to obtain an output recovery operator; and (v) applying the recovery operator to the QECC of the array.

In some embodiments, steps (iv) and (v) are performed by a classical processing device, in response to transmission of the syndrome from the quantum processing device to the classical processing device.

In some embodiments, the device comprises a plurality of bilinear arrays of quantum dots, and wherein the controller is further configured to: selectively couple, via a coherent coupling mechanism, a first L1 logical qubit of a first bilinear array to a second L1 logical qubit of a second bilinear array, wherein the coupling occurs by long range interaction based transportation of the information encoded by the first L1 qubit into the second L1 qubit; and perform one or more fault tolerant quantum processing operations on the L1 logical qubits of the plurality of bilinear arrays.

In some embodiments, the coherent coupling mechanism includes a quantum transportation structure configured to connect the plurality of bilinear arrays, to enable the controller to selectively couple the first and second L1 logical qubits by the coherent transportation of one or more spin qubits between the first bilinear array and the second bilinear array connected to the first array.

In some embodiments, the quantum transportation structure comprises one or more shuttling arrays of quantum dots, each shuttling array disposed between connected pairs of the bilinear arrays.

In some embodiments, the controller is further configured to couple the first and second L1 logical qubits by creating entangling operations between one or more of the spin qubits of each array of the pair by: transferring the spin qubits from one array of the pair to the other array of the pair; and performing one or more entangling operations between the transferred spin qubits.

In some embodiments, the controller is further configured to perform a fault tolerant CNOT gate between a control array of the plurality of bilinear arrays and a target array of the plurality of bilinear arrays by: coherently transporting the spin qubits from the control array to the target array via the quantum transportation structure; performing a nearest-neighbour CNOT gate between pairs of one or more of the data qubits of the QECC; coherently transporting the spin qubits from the target array back into the control array; and performing a cycle of error correction for each of the control and target arrays.

In some embodiments, the controller is further configured to apply a second-level QECC, to encode the collective state of a set of the L1 logical qubits as a corresponding second-level (L2) logical qubit.

In some embodiments, the distance of the second-level QECC is arbitrarily scalable with a number M>1 of the bilinear arrays of the device.

There is also provided a quantum processing device comprising: a plurality of bilinear arrays of quantum dots, each array configured to hold a plurality of at most N spin qubits; a controller configured to: control the coherent transportation of one or more of the plurality of qubits within each array to implement a first-level QECC to encode the collective state of the spin qubits of the array as a corresponding first-level (L1) logical qubit; and selectively couple, via a coherent coupling mechanism, one or more pairs of L1 logical qubits of the plurality of bilinear arrays, to implement a second-level QECC to encode the collective state of a set of M>1 of the L1 logical qubits as a corresponding second-level (L2) logical qubit, wherein the coupling is performed, for each pair, by long range interaction based transportation of the information encoded by a first L1 qubit of the pair into a second L1 qubit of the pair, such that the first-level QECC reduces an error rate of the spin qubits to a lower error rate of the L1 logical qubits, and the second-level QECC further reduces the lower error rate of the L1 logical qubits to a further lower error rate of the L2 logical qubit.

In some embodiments, the coherent coupling mechanism includes a quantum transportation structure configured to connect the plurality of bilinear arrays, to enable the controller to selectively couple the one or more pairs of L1 logical qubits by, for each pair, coherent transportation of one or more spin qubits between a first array of the pair, and a second array of the pair connected to the first array.

In some embodiments, the controller is further configured to perform a set of fault tolerant quantum processing operations with one or more L2 logical qubits of the device.

There is also provided a method for performing a fault tolerant quantum processing operation, the method executed by a quantum processing device described herein, the method comprising: determining at least two connected bilinear arrays to perform a quantum processing operation; selecting one or more pairs of the determined connected bilinear arrays, and for each selected pair including a first array and a second array: (i) coherently transporting at least a subset of the spin qubits from the first array to the second array; (ii) performing individual entangling operations between the spin qubits within the second array; (iii) reversing the coherent transportation of step (i); and (iv) performing a cycle of error correction on each of the first and second arrays, wherein the cycle of error correction is enabled by any of the methods described herein.

### BRIEF DESCRIPTION OF DRAWINGS

Some embodiments of the invention will now be described with reference to the accompanying drawings, in which:

FIG. 1A is a schematic diagram of a quantum processor in accordance with some embodiments;

FIG. 1B is a schematic diagram of a bilinear array of quantum dots of the first quantum processor of FIG. 1A;

FIG. 1C is a schematic diagram of part of a quantum processor with a plurality of bilinear arrays coupled via a coherent coupling mechanism, in accordance with some embodiments;

FIG. 1D an illustration of an exemplary layout of the quantum processor of FIG. 1C;

FIG. 1E is an illustration of a means of qubit control for the controlling the bilinear arrays of the quantum processor of FIG. 1C;

FIG. 1F is an illustration of a means of coherent transportation of qubits between a pair of bilinear arrays of the quantum processor of FIG. 1C;

FIG. 2A is a cross-sectional view of a qubit device circuit schematic to achieve shuttling of spin qubits;

FIG. 2B is a stability diagram of charge transfer for shuttling of spin qubits;

FIG. 3A is a flow diagram of a method for enabling quantum error correction on a quantum processing device in accordance with some embodiments;

FIG. 3B is a flow diagram of a method for performing execution of a syndrome extraction circuit in accordance with some embodiments;

FIG. 4A is a schematic diagram of an implementation of the Surface-17 code on a bilinear array of the processor of FIGS. 1A-D;

FIG. 4B is a schematic diagram of the stabilizers of the Surface-17 code implemented on a bilinear array of the processor of FIGS. 1A-D;

FIG. 5 is a circuit diagram of a syndrome extraction circuit for the Surface-17 code in accordance with some embodiments;

FIG. 6 is a schematic diagram of rounds of quantum error correction for one cycle of the Surface-17 code in accordance with some embodiments;

FIG. 7A is a flow diagram of a simulation model used to assess the performance of quantum error correction in a 2×N array of quantum dots in accordance with some embodiments;

FIG. 7B is a circuit identity diagram representing an implementation of a CNOT gate based on a combination of a CZ gate and 2 Hadamard gates;

FIG. 7C is a circuit diagram showing the propagation of Pauli errors in CNOT gates according to an example configuration of gates;

FIG. 8 is a graph illustrating the logical failure rate of a quantum error correction code for L1 logical qubits encoded in the 2×N module according to the error model for shuttling of FIG. 7A;

FIGS. 9A and 9B are circuit diagrams illustrating the logical |0 [symbol] and logical |+ [symbol] fault-tolerant logical encoding circuits to initialize the respective states for the Surface-17 code;

FIGS. 10A and 10B are circuit diagrams of the logical CNOT gate between two L1 qubits of coupled 2×N modules, at the logical level and the physical level respectively, in accordance with some embodiments;

FIG. 11 is a flow diagram of a method to couple (entangle) two logical qubits, encoded in two separate 2×N arrays, in accordance with some embodiments;

FIG. 12 is a schematic diagram of the coherent transportation of underlying spin qubits in the formation of a CNOT gate over a pair of L1 logical qubits, in accordance with the method shown in FIG. 11; and

FIG. 13 is a graph of the failure rate of the logical |Φ′ [symbol] preparation in an evaluation of a transversal based two qubit gate.

### DESCRIPTION OF EMBODIMENTS

Previous approaches to the design of quantum processing architectures and corresponding devices have typically utilized lattice-based structures to create and manipulate the qubits. Quantum error correction may be achieved by forming logical qubits using a QECC applied on portions of the lattice, such as for example square sections of a predetermined dimension. The practical realization of a fault-tolerant quantum computing architecture benefits from an error rate of the processing qubits (i.e., the qubits on which quantum operations are conducted) to be reduced to ~10⁻¹⁵ (see Delfosse [1]).

Reducing the error rate requires the use of a code with a larger number of qubits (i.e., to increase the code distance). However, the difficulty of implementing quantum error correction grows (often non-linearly) with the distance between a given qubit and the edge of the structure. A practical limitation on the error rate of the logical qubits often results from interconnect costs and layout difficulties of conventional architectures. As a result it is challenging to design a conventional lattice-based architecture that is both suitable for a high-distance QECC (as needed to achieve a sufficiently low logical qubit error rate), and that is practically realizable using currently available fabrication techniques.

Further, the structures applicable to achieve a practical fault-tolerant quantum computing architecture will depend on the physical platform of the devices. In previous work, neutral atom-based qubits have been transported across spatial structures (see Bluvstein [2]). However, neutral atom qubits differ significantly from qubits formed in other platforms, such as those utilizing spins of a charge carrier (i.e., an electron or hole) in a solid-state host (known as “spin qubits”). The movement operations performed on the qubits of the respective platforms therefore fundamentally differ. For example, neutral atoms are trapped and shuffled around by lasers using optical tweezers whereas spin qubit transportation relies on electric field control. Laser-based tweezer control of neutral atoms may experience scalability difficulties associated with the resolution and optical aberrations. By contrast, gate-based electric control of spin qubits has strong scalability that is practically achievable based on the manufacturing capabilities of the metal-oxide semiconductor (MOS) device industry.

In other approaches, error correction is performed over a 2D qubit lattice of one-dimensional structures in which electrons are moved to symmetry points of a nanomagnet array, for example to perform exchange interaction-based qubit operations (see Mohiyaddin [3]). It is desired to devise techniques that ameliorate these drawbacks, or one or more other drawbacks of the prior art, or that at least provide a useful alternative.

### Overview

Disclosed herein are devices and methods for fault tolerant quantum processing in which high-quality logical qubits are encoded by the application of quantum error correction to bilinear arrays of quantum dots. In one aspect, the proposed architecture is based on a qubit module that includes a bilinear array configured to hold a plurality of physical spin qubits. A controller is configured to control the coherent transportation of one or more spin qubits within each array (referred to as “shuttling”). The quantum information stored within the spin qubits of an array collectively forms a first-level (L1) logical qubit, and the shuttling of the qubits enables the implementation of a QECC, such as a surface code, to protect the L1 logical qubit in the presence of errors in the spin qubits.

It is an advantage that the proposed architecture enables the formation of logical qubits of a quantum processing device by arranging the physical qubits according to a linear structure. The architecture provides scalability in that it is able to perform computations with a physical arrangement of qubits that is easier to control with a practically realizable fan-out, compared to the denser arrangements in conventional surface code architectures, such as for example those using a square lattice of qubits. Furthermore, the proposed architecture is naturally suited to the use of silicon-based spin qubits realized by the electrons of respective silicon metal-oxide semiconductor (SiMOS) quantum dots. In this way, the design and fabrication of the quantum device may be achieved in a realistic process using modern transistor foundries.

In some embodiments, the bilinear array is organized in two lines each of N quantum dots (referred to as a “2×N array”), where the 2×N array is configured to hold at most N qubits. For example, the present disclosure describes a 2×N array comprised of SiMOS quantum dots, where the qubits are the respective spins of electrons held in the dots.

The relative arrangement of the spin qubits in the 2×N array is selectively configured to facilitate the shuttling of the qubits (i.e. the electrons) for operations that implement a QECC for the L1 logical qubit. The spin qubits are held according to the arrangement in a first line of the array enabling initialization, quantum computation, and read-out of the QECC qubits. A second line of the array enables entangling operations to be performed between arbitrary spin qubits via shuttling (also referred to as the “shuttling line” of the array).

In the present disclosure, the L1 logical qubits are encoded by a QECC in the form of a low distance (“small”) surface code such as, for example, Surface-17. The arrangement of the qubits in the first line of the 2×N array minimizes the depth of a corresponding syndrome extraction circuit of the code, as scheduled for the array. Optimization techniques are applied to determine an arrangement that facilitates the shuttling of one or more of the plurality of spin qubits in the array (e.g., by minimizing errors associated with the shuttling). For example, one or more numerical tools based on Simulated Annealing and the Metropolis algorithm may be applied to determine the arrangement. Simulation results demonstrate that a full cycle of the Surface-17 code can be scheduled to the 2×N array using a total of 8 steps (circuit depth of 8), which is just 2 rounds more than the optimal depth of 6 when the qubits are laid out in a square lattice.

In a further aspect, the proposed architecture comprises a plurality of bilinear arrays. The controller is configured to control the shuttling of the plurality of qubits within each array (i.e., to implement a QECC encoding the L1 logical qubit), and to selectively couple respective pairs of a first L1 logical qubit of a first bilinear array to a second L1 logical qubit of a second bilinear array. L1 logical qubit coupling operations can also be enabled by other coupling mechanisms based on long range interaction-based transportation of the information encoded by the first L1 qubit into the second L1 qubit. A second level (L2) logical qubit may therefore be constructed by controlling and coupling L1 logical qubits.

An exemplary coupling mechanism includes a quantum transportation structure that connects the arrays, such that coupling of L1 logical qubits occurs by the coherent transportation of one or more spin qubits between respective mutually connected arrays of the plurality. In one example, each array in the architecture is connected to at least one other array via separate shuttling arrays of quantum dots. In this way, shuttling of the underlying spin qubits is enabled between mutually connected 2×N array pairs. In other examples, the coupling mechanism may include a quantum transportation array of an alternative physical configuration, such as a patch or bus of quantum dots, and/or one or more other coupling devices (e.g., a super-conducting coupler).

The controller performs fault tolerant quantum processing operations on a set of L1 logical qubits of the plurality of bilinear arrays. The ability to perform a universal set of arbitrary quantum operations on the L1 logical qubits enables the use of these logical qubits as the underlying qubits to which further error correction methods may be applied.

In one implementation, a first QECC is applied to each 2×N array to reduce an error rate of the spin qubits (e.g., ~10⁻⁴) to a lower error rate of a corresponding L1 logical qubit. For example, evaluations with a logical CNOT gate demonstrate an ability to achieve an error rate of ~10⁻⁵ for the L1 logical qubit. Then, a second QECC is applied to encode the collective state of a set of the L1 logical qubits as a corresponding L2 logical qubit. The L2 logical qubit possesses a further reduced error rate relative to the lower error rate of the L1 logical qubits (e.g., approaching the desired value of 10⁻¹⁵).

For example, by selecting a number M>1 of L1 logical qubits in the set, the distance of the second-level code may be expanded in order to achieve arbitrarily well protected (L2 logical) qubits. The formation of L2 logical qubits according to the proposed architecture therefore provides a solution to the problem of a lack of scalability of single 2×N arrays for achieving improved quantum error correction. The total number of qubits utilized for error correction may be increased by increasing the number M of L1 qubits, while maintaining a fixed size N of the underlying bilinear arrays.

In at least this manner, the proposed architecture advantageously facilitates performing fault tolerant quantum processing by enabling a scalable, practical and universal approach to error correction over two levels of logical qubits.

### Quantum Processor

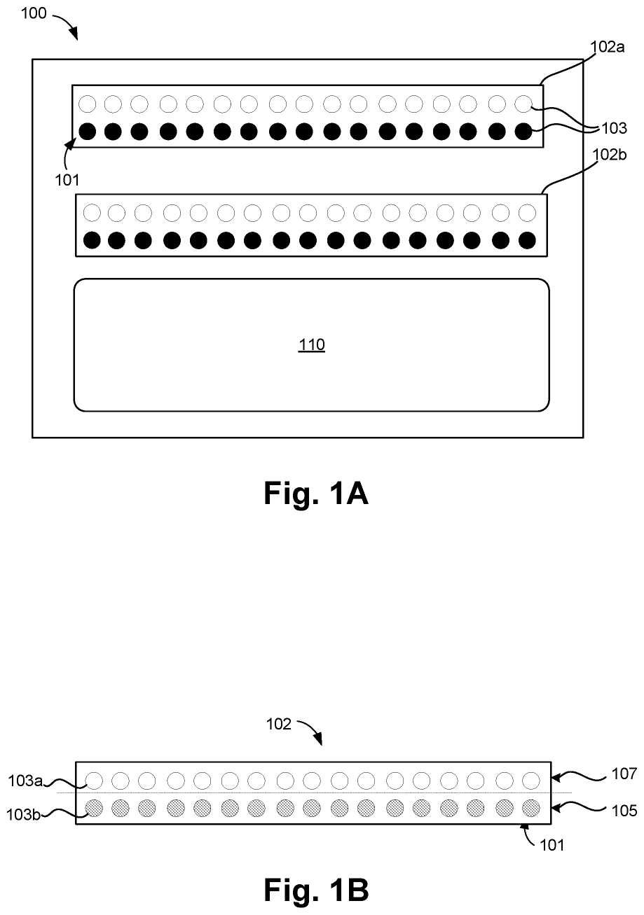

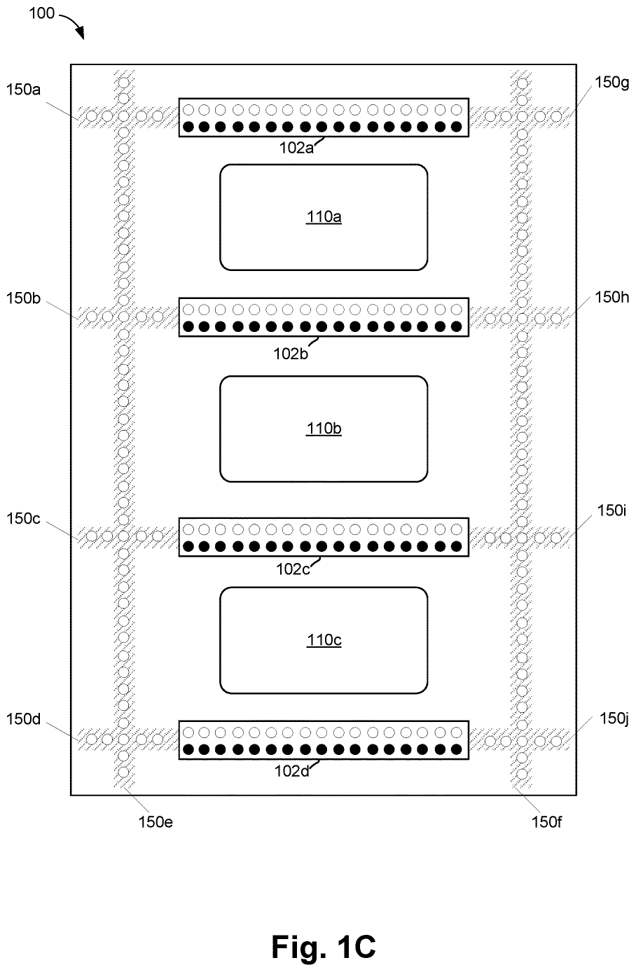

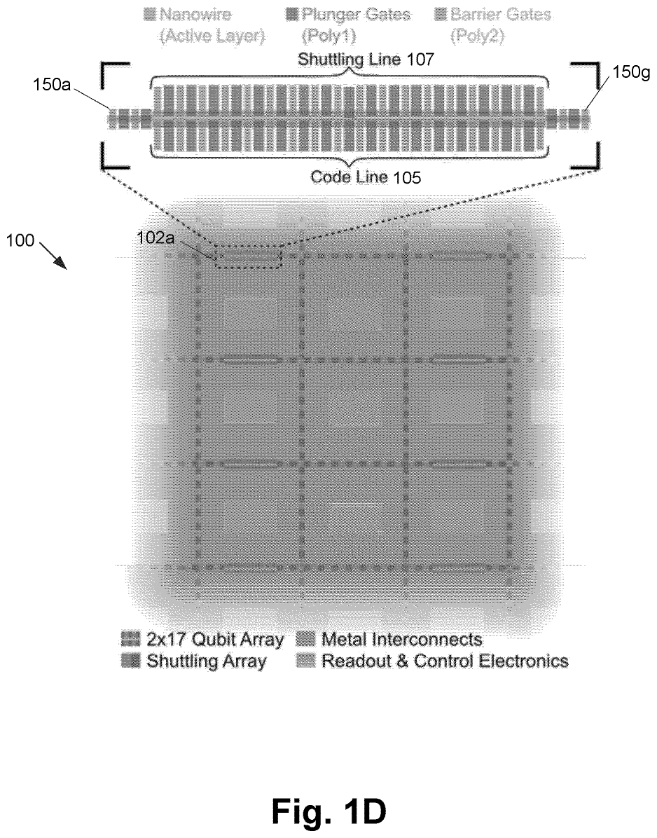

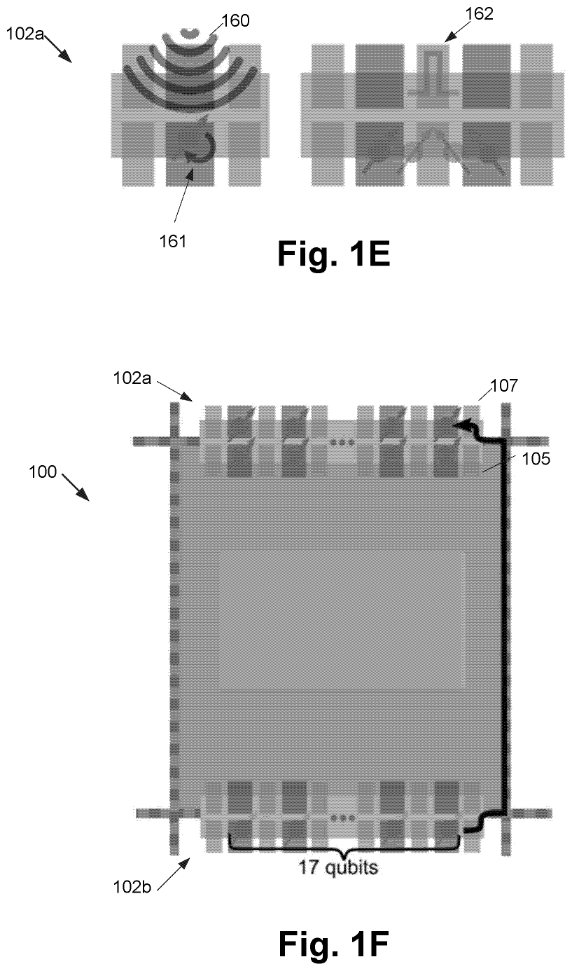

FIG. 1A illustrates a quantum processor 100 comprising at least one bilinear array, such as the plurality of arrays 102a 102b. The qubits 101 (filled) are spin qubits realized within corresponding quantum dots 103 (filled and empty circles) of the arrays 102a 102b. The qubits of processor 100 are digital qubits in that each represents information in a digital form, such as electron or nucleus spins, or superconducting qubits using Josephson Junctions. Digital qubits of each array 102a 102b may have a particular functional role, such as a data qubit or an ancilla qubit of a QECC implemented by the processor 100.

Quantum processor 100 also comprises a controller 110 configured to control the coherent transportation (referred to as “shuttling”) of one or more of the qubits held within each of the arrays 102a 102b. The shuttling is controlled by the controller 110 to implement, on at least one of the arrays 102a 102b, a QECC that encodes the collective state of the spin qubits of the respective array as a corresponding first-level (L1) logical qubit. In this sense, the controller 110 applies a first method of error correction, being the formation of the QECC and generation of a L1 qubit on each of the arrays 102a 102b. In some embodiments, the QECC is a surface code that reduces an error rate of the physical spin qubits to a relatively lower error rate of each L1 logical qubit of the respective arrays 102a 102b.

Each array 102a 102b is configured to hold multiple qubits in corresponding quantum dots 103. That is, each quantum dot 103 may hold a qubit, or not, at any given time. The “holding” of each qubit by the array refers to the localization of the physical qubit (e.g., an electron) in a position (or “address”) of the array. For example, a qubit 101 may be realized as the spin state of an electron held by the quantum dot 103.

FIG. 1B illustrates an exemplary bilinear array 102 implemented as arrays 102a 102b in the exemplary processor 100 of FIG. 1A. In other examples, processor 100 may be configured with a single array, or with any arbitrary real positive number of arrays. Array 102 is configured as two lines, each of N quantum dots, collectively referred to as a “2×N” array. Each single 2×N array 102 is configured with a first (bottom) line 105 to hold at most N spin qubits 101 and a second (top) line 107 to enable the shuttling of spin qubits 101 within the array 102. That is, in such embodiments shuttling of the spin qubits occurs between the first and second lines of the bilinear array 102. In other embodiments, the shuttling line may be implemented as the first (bottom) line, with the qubits held in the second (top) line. Quantum dots 103 holding spin qubits 103b are depicted as shaded rounded squares in the illustrations, while empty quantum dots 103a are depicted as non-filled rounded squares.

In the described embodiments, 2×N array 102 comprises a set of SiMOS quantum dots. In one implementation, the electron spin of each SiMOS quantum dot is confined to the interface between Silicon and SiO2 in a quantum dot. SiMOS quantum dots offer advantages for quantum computation including long coherence times, the ability to be controlled to perform quantum logic operations, and are extensible. SiMOS quantum dots also have long-range qubit interactions, via qubit shuttling, as discussed below.

FIGS. 1A and 1B illustrate the geometry of the 2×N array 102 in terms of an abstraction in two dimensions (i.e., as a simple double line). It will be apparent that, in a practical implementation of the processor 100, the arrays are fabricated according to a three-dimensional layout and with a particular fan out. For example, in one implementation the gates may be densely packed along an arrangement of one-dimensional channels that sustain the electrostatic quantum dots, but may be contacted by three-dimensional metal layers with a predetermined pitch between the interconnects. Furthermore, controller 110 may be configured according to any one or more possible layouts, relative to the plurality of arrays, including layouts in which the controller 110 is physically separated into two or more sub-controllers, or portions of readout and/or control electronics circuitry, each controlling a predetermined group of arrays from the plurality of arrays (although collectively operating as a single logical controller for the processor).

### Coherent Transportation of Spin Qubits

High fidelity coherent transportation of an electron spin qubit between quantum dots (referred to as “shuttling” of a spin qubit) has been demonstrated in isotopically enriched silicon (see Yoneda [4]). In a double quantum-dot system, a single electron spin can be coherently transported between a pair of metal-oxide-semiconductor (MOS) quantum dots.

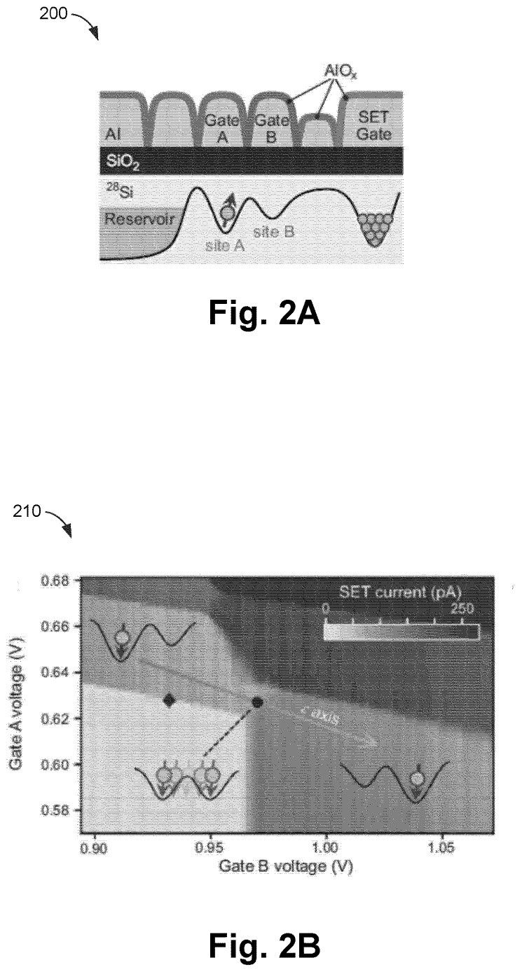

FIG. 2A illustrates a cross-sectional schematic of a qubit device circuit 200 of Yoneda [4] configured to achieve coherent spin transfer between corresponding quantum dot sites. A single electron is loaded into quantum dot site A and manipulated by gate-voltage pulses applied on aluminum metal gates A and B. The single electron is moved between sites A and B by biasing the voltages applied to the surface gate electrodes.

The gate voltages are swept along a detuning axis E, which changes the energy difference between the states localized in individual sites. FIG. 2B illustrates a stability diagram 210 of charge transfer of Yoneda [4]. Charge configuration in the dot array is mapped through the SET current and there are two and one charge transition lines for sites A and B, respectively, in the plotted area. The arrow defines the gate-voltage axis used for qubit transport, ε. As ε is increased, the site where the electron resides changes from A to B. The interdot transition (ε=0) is marked by a circle. Spin initialization and readout is performed at the diamond using spin-selective tunneling from site A to the reservoir in combination with charge sensing.

The polarization of the spin can be transported between sites with high fidelity. Spin-flip tunneling site A to B (e.g., due to the spin-orbit field generated by the electron movement or a small site difference in spin quantization) is avoided by increasing the tunnel coupling above the Zeeman energy (~28 GHz). A large tunnel coupling will also suppress state leakage due to non-adiabatic tunneling.

Results of evaluations in Yoneda [4] show that the transfer process can be regarded as a unitary phase rotation gate with an average gate fidelity of (99.36±0.05)%. The physical mechanisms expected to limit the transfer fidelity in a longer chain are largely present in the double-dot system evaluated. Extrapolating the observed coherence loss p~2% for a transfer between neighboring sites would correspond to spin transfer across ~50 sites before the phase coherence decays to 1/e, or a distance ~2 μm (assuming a 40 nm site spacing). If only the spin polarization is needed e.g., for qubit readout, the electron could be transported over 2500 sites (or ~100 μm) before the polarization decays to 1/e for the spin-up case.

Further, the results illustrate that the qubit frequency is best-fit with a small spin-dependence in the interdot tunnel coupling due to spin-orbit interaction. Furthermore, a detuning spot occurs roughly around ε=−7 mV where the qubit frequency is first-order insensitive to detuning fluctuations due to charge noise, as a result of competition between the Stark shift and the tunneling hybridization. Further approaches for coherent transportation of spin qubits are described in International Patent Publication No. PCT/AU2021/050869, the content of which is incorporated herein by reference. Despite this, qubit shuttling can be completed within nanoseconds, which is several orders of magnitude faster than the qubit dephasing time. This provides an advantage for facilitating coherent electron shuttling in fault-tolerant quantum computing architectures that utilize 2×N arrays as described herein.

### Quantum Error Correction in a 2×N Array

A quantum processing architecture based on linear arrays of electron spin qubits, as formed by silicon metal-oxide-semiconductor (SiMOS) quantum dots, advantageously possesses long coherence times and can therefore be controlled to perform the desired quantum logic operations. The linear structure also promotes an ability to leverage long-range qubit interactions for qubit shuttling (i.e., the coherent transportation of spin qubits through the array), and can be achieved using a layout configuration of densely packed gates.

However, implementing quantum error correction for these linear architectures is challenging due to the constraints imposed on the qubit geometry. This disclosure provides an approach to correcting errors in quantum processing by applying coherent qubit transportation operations, as discussed above, for the purpose of translating a QECC onto the constrained geometry of the 2×N array.

Error Correction with First-Level Logical Qubits

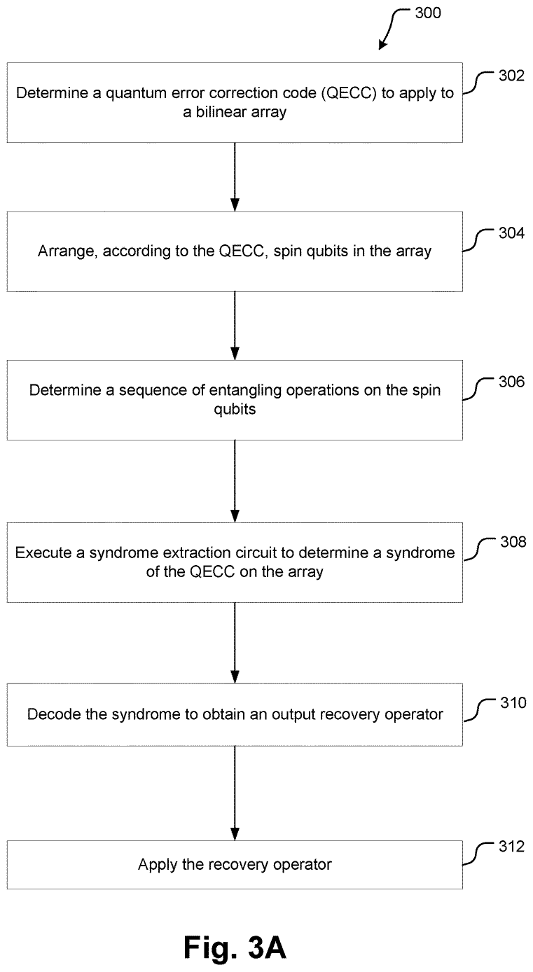

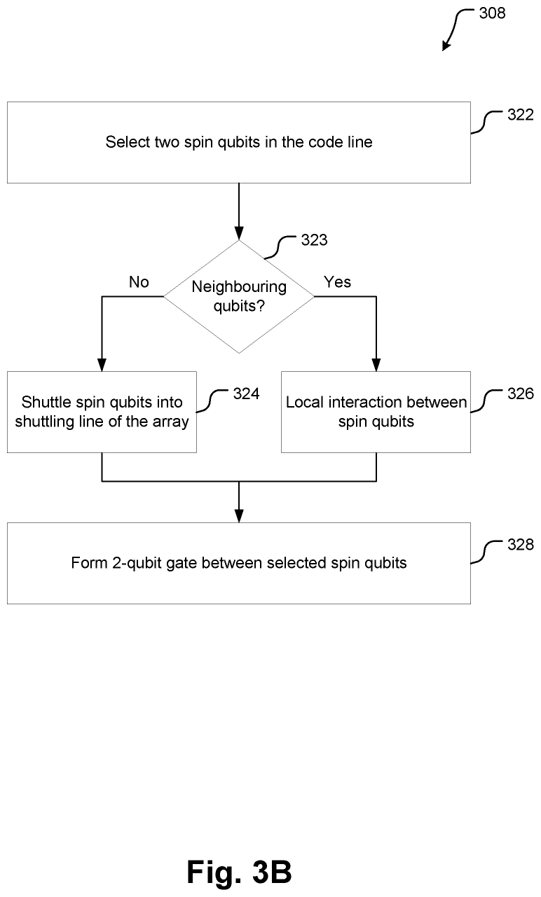

FIG. 3A illustrates a method 300 for enabling quantum error correction on a quantum processing device, such as for example a quantum processor, according to the architecture described herein. At step 302, a QECC is determined for application to each of one or more bilinear arrays of quantum dots of the device, where each array is configured to hold a plurality of spin qubits. Each array is configured as a 2×N array with N spin qubits. The QECC is a surface code with a distance d, such as Surface-17 (see Tomita [5]).

At step 304, the spin qubits in each 2×N array of the device are arranged according to the QECC such that the collective state of a subset of the spin qubits forms a first-level (L1) logical qubit protected by the QECC. At step 306, a sequence of one or more entangling operations is determined on respective pairs of the plurality of spin qubits in each 2×N array. The qubit arrangement and entangling sequence determination (also referred to as “scheduling”) enable the execution of a syndrome extraction circuit in the geometry of the 2×N array (or “module”), as performed at step 308. The sequence of entangling operations involves the coherent transportation of one or more of the plurality of spin qubits in each 2×N array.

At step 310, the syndrome obtained from the execution of the extraction circuit passes through a decoder, which outputs a recovery operator. This operator is then applied back to the code, returning it to the code space (i.e., at step 312). In some embodiments, the steps of method 300 are performed entirely by the quantum processing device. In other embodiments, at least the decoding 310 and recovery 312 steps are performed by a classical processing device. For example, the classical processing device may be configured to instruct the quantum processing device to generate the syndrome, and to perform decoding and recovery in response to transmission of the generated syndrome from the quantum computing device to the classical processing device.

Various embodiments are described below for a quantum processor 100 implementing a method of quantum error correction 300 with L1 logical qubits.

### Surface Codes

Surface codes are a type of topological QECC implemented over a 2D planar qubit layout with nearest-neighbor interactions. A surface code encodes a single logical qubit in a number of physical qubits as determined by a code distance d and a desired layout. A first-level QECC is applied to encode the collective state of the spin qubits 101 of 2×N array 102 as a corresponding first-level (L1) logical qubit. In one example, the QECC determined at step 302 is a surface code, such as the Surface-17 code. Surface-17 is a distance d=3 QECC which requires N=17 physical qubits, as shown in FIGS. 1A and 1B.

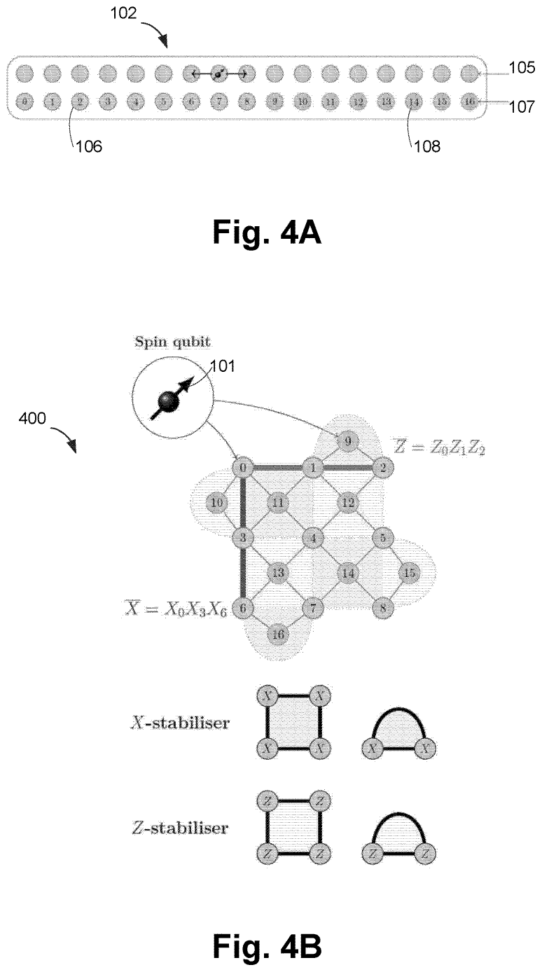

FIG. 4A illustrates a 2D abstraction of an array 102 on which the Surface-17 code is implemented where 9 data qubits (labelled 0 to 8) store the logical information of the code, and 8 ancilla qubits (labelled 9 to 16) perform the projective measurements required for error correction.

Surface-17 stores one logical qubit whose logical X (Z) operator can be controlled at the physical level through performing X (Z) Pauli operations in a column of Pauli X (row of Pauli Z) operations. For example, the operation X̅=X₀X₃X₆(Z̅=Z₀Z₁Z₂) applies a Pauli operation to the logical qubit. FIG. 4B schematically illustrates an arrangement 400 of the stabilizers of Surface-17 code defined as tensor products of the Pauli X (Pauli Z) operators around the respective data qubits. Explicitly, the weight-4 and weight-2 stabilizer groups are defined as:

$${S}_{1}^{x} = {X}_{0} {X}_{1} {X}_{3} {X}_{4}$$

$${S}_{2}^{x} = {X}_{1} {X}_{2}$$

$${S}_{3}^{x} = {X}_{4} {X}_{5} {X}_{7} {X}_{8}$$

$${S}_{4}^{x} = {X}_{6} {X}_{7}$$

$${S}_{1}^{z} = {Z}_{0} {Z}_{3}$$

$${S}_{2}^{z} = {Z}_{1} {Z}_{2} {Z}_{4} {Z}_{5}$$

$${S}_{3}^{z} = {Z}_{3} {Z}_{4} {Z}_{6} {Z}_{7}$$

$${S}_{4}^{z} = {Z}_{5} {Z}_{8}$$

The code state of a QECC is defined as the +1 eigenstate of the stabilizer group. The

$$( {S}_{i}^{j} ) ,$$

∀1≤i≤4, j∈{x, y} form a group under multiplication. For example,

$${S}_{1}^{x} {S}_{2}^{x}$$

also stabilizes the code state:

$${{{{S}_{1}^{x} {S}_{2}^{x} \vert \overline{ψ} 〉}_{L} = {S}_{1}^{x} ( + 1 ) \vert \overline{ψ} 〉}_{L} = ( + 1 ) \vert \overline{ψ} 〉}_{L} .$$

The logical qubit of Surface-17, |ψ̅ [symbol] is encoded, such that:

$${{{{S}_{i}^{x} \vert \overline{ψ} 〉}_{L} = ( + 1 ) \vert \overline{ψ} 〉}_{L} = {S}_{i}^{z} \vert \overline{ψ} 〉}_{L} ∀ i ∈ \{ 1 , 2 , 3 , 4 \} .$$

For an error process on the code,

$$ℰ = {⊗}_{i = 0}^{8} {E}_{i}$$

where Eᵢ∈{X, Y, Z} is the Pauli error on the i-th physical qubit of the code.

Information about the parity of errors that have occurred is obtained by measuring the eigenvalues of the stabilizers. An eigenvalue of −1 indicates the presence of an odd parity of errors acting on the support of the stabilizer—that is, on the qubits the stabilizer acts non-trivially on (e.g. for

$${S}_{1}^{x} = {X}_{0} {X}_{1} {X}_{3} {X}_{4} ,$$

these would be qubits 0, 1, 3 and 4). X-type (Z-type) stabilizers detect an odd parity of Z (X) errors.

To illustrate this, take ε=Z₀ (phase-flip on qubit 0, identity on remaining qubits). Only stabilizer

$${S}_{1}^{x}$$

will return an eigenvalue of −1 as, although qubit 0 is part of both the

$${S}_{1}^{x} and {S}_{1}^{z}$$

stabilizers, it anti-commutes with the former and commutes with the latter (using XZ=−ZX):

$${{{{S}_{1}^{x} {Z}_{0} \vert \overline{ψ} 〉}_{L} = ( - 1 ) {Z}_{0} {S}_{1}^{x} \vert \overline{ψ} 〉}_{L} = ( - 1 ) {Z}_{0} \vert \overline{ψ} 〉}_{L} ,$$

$${{{{S}_{1}^{z} {Z}_{0} \vert \overline{ψ} 〉}_{L} = ( + 1 ) {Z}_{0} {S}_{1}^{z} \vert \overline{ψ} 〉}_{L} = ( + 1 ) {Z}_{0} \vert \overline{ψ} 〉}_{L} , and ℰ = {Z}_{0}$$

which trivially commutes with every other stabilizer, as it does not overlap with their support

$$( e . g . {S}_{2}^{x} = {X}_{1} {X}_{2}$$

does not act non-trivially on data qubit 0). The syndrome of the code is the collection of −1 stabilizer readings. For ε=Z₀, the syndrome is

$$S ( ε ) = \{ {S}_{1}^{x} \} .$$

Performing the quantum error correction of method 300 involves measuring the stabilizers of the QECC to obtain the syndrome. However, the data qubits cannot be directly measured on the support of the stabilizers, since this would decohere the stored quantum information. Instead, the measurements are projected onto ancillary qubits, which are then subject to readout. The sequence of operations required to extract the stabilizer information of the code, through the ancilla qubits, is known as the syndrome extraction circuit (SEC).

### Gate Scheduling and Qubit Arrangement

To execute the SEC the operations of the surface code, such as Surface-17 are mapped to the 2×N array. To start, the qubits of the QECC are formed in the first line 107 of the array, such as for example in the arrangement shown in FIG. 4A. The qubits of the Surface-17 are laid out in the first line 107 of the array 102, and the second line 105 is left empty to be used for shuttling qubits and performing arbitrary, non-local, 2-qubit gates. Scheduling refers to determining the sequence of gates to perform in order to couple the spin qubits via respective shuttling operations of the array 102.

Ancilla qubits 108 are initialized by tunneling electrons from a reservoir placed around the array 102, in close proximity to the quantum dots. Nearest neighbor and shuttled 2-qubit gates can be performed one at a time, by using the second line 105 for shuttling, when necessary.

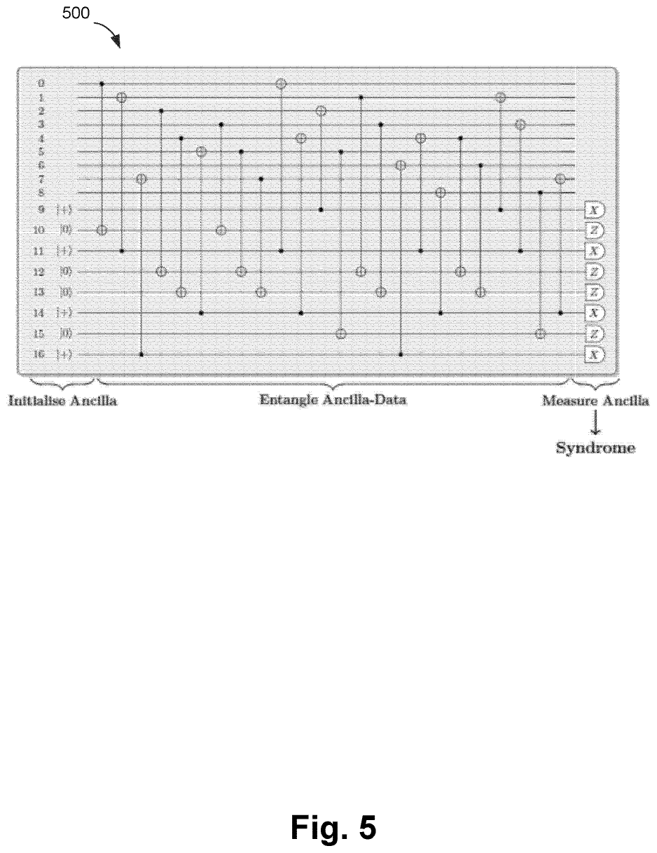

Due to the geometrically constrained architecture of the 2×N array, few operations can be done in parallel. For example, the shuttling paths required to implement the first two CNOT gates of the SEC (e.g., CNOT|0 [symbol] |10 [symbol] , and CNOT|11 [symbol] |1 [symbol] for the example SEC 500 of FIG. 5) cross in the array, and therefore must be performed [symbol] in separate rounds, one at a time. The total number of separate rounds required to execute the circuit is known as the circuit depth. The longer the circuit takes to execute, the longer the spin qubits are left idling and exposed to the undesirable decoherence effects of the environment.

This leads to an accumulation of errors which corrupts the error correction capabilities of the scheme. In the standard layout of the qubits of Surface-17 (the 2D arrangement 400 shown in FIG. 4B), the depth of the circuit is 6. In the naive arrangement of FIG. 4A, the depth of the circuit is 26, which is the worst possible depth of the circuit (i.e., where every operation is performed serially).

In the method 300, the qubits are instead arranged selectively to facilitate shuttling the one or more of the plurality of spin qubits for performing error correction according to the QECC. That is, for the examples described, a re-arranging of the qubits in the first line 107 of the array 102, from their initial placement, is performed in a way that enables multiple 2-qubit gates to be implemented at the same time, without shuttling paths crossing (i.e., such that at least some of the entangling gate operations can be performed in parallel during the SEC).

In the described embodiments, the arrangement of the qubits in the first line 107 of the array 102 is determined to minimize the depth of the SEC or to provide an approximation to this minimal depth. The qubit arrangement which minimizes the circuit depth can be approximated using techniques from the Simulated Annealing algorithm and the Metropolis sampling algorithm.

Let σ represent a certain qubit arrangement in the first line 107 of the array 102 and define E(σ) as the objective (energy) function that is to be minimized over. In this case, this is the depth of the circuit E(σ)=Circuit depth(σ). The pseudocode of an algorithm to arrange the qubits to approximate this minimal depth is given below.

Simulated annealing based determination of the qubit arrangements

| | |
|---|---|
| 1: | for T = T_{high} to 0 do |
| 2: | for round = 1 to N do |
| 3: | σ′ = σ(i ↔ j) (proposed) |
| 4: | if E(σ′) < E(σ): then |
| 5: | Choose σ = σ′ |
| 6: | else |
| 7: | r = random(0,1) |
| 8: | if r ≤ e^{-[E(σ′)-E(σ)]/T} then |
| 9: | Choose σ = σ′ |
| 10: | end if |
| 11: | end if |
| 12: | end for |
| 13: | end for |
| 14: | Return σ |

At each step of the algorithm (line 3) anew qubit configuration is proposed by swapping two neighboring qubits, σ′=σ(i↔j). If the energy of the new configuration is lower than the energy of the current configuration, E(σ′)<E(σ), then it is accepted immediately. Otherwise, it is accepted with a probability p, which is given by the ratio of the Boltzmann factors for each configuration:

$$p = \frac{{e}^{- E ( {σ}^{′} ) / T}}{{e}^{- E 〈 σ ) / T}} = {e}^{- [ E ( {σ}^{′} ) - E ( σ ) ] / T} .$$

The algorithm initially starts sampling at a high temperature T=T_{high}. This means that, initially there is a reasonable likelihood of accepting a sub-optimal solution (i.e., a higher energy qubit arrangement). This prevents the algorithm from getting stuck in local minimum metastable states. Slowly, the temperature decreases, and so does the probability of accepting worse configurations. Eventually, the temperature tends to 0 and the algorithm settles on the approximate optimal configuration which minimizes the energy function.

There may be more than one possible qubit arrangement which minimizes the circuit depth. In some implementations, step 304 involves selecting the qubit arrangement to perform syndrome extraction as the arrangement with the minimal number of shuttled 2-qubit gates, since it is expected that these may be the worst performing gates of the circuit. That is, once the desired arrangement is determined at step 304, the sequence of 2-gate entangling operations are determined at step 306.

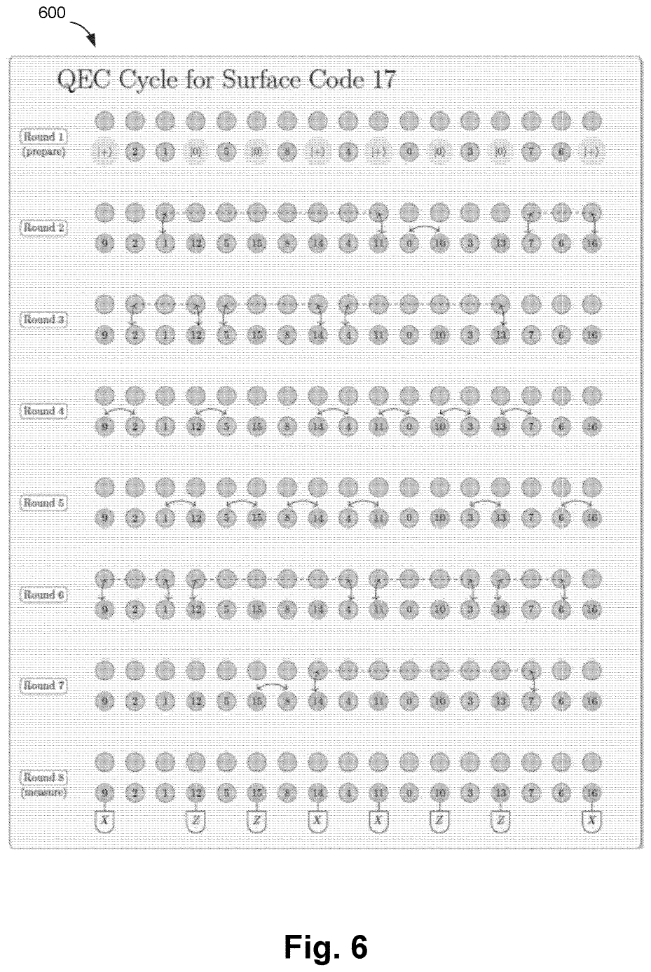

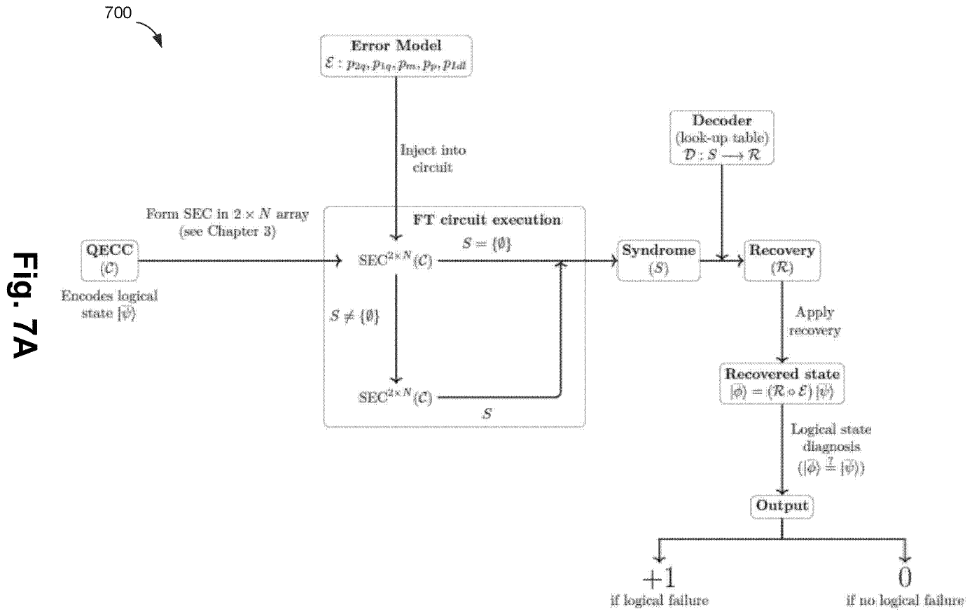

The desired qubit arrangement for Surface-17, as obtained by minimizing over depth and subsequently over total number of shuttled 2-qubit gates, is shown in FIG. 6. In some embodiments, the desired (i.e., optimal or near optimal) arrangement is already known to the processor 100, such that step 304 involves laying out the qubits according to the desired arrangement. In some embodiments, the sequence of (2-gate or other) entangling operations are determined prior to, or concurrently with, the determination of the desired arrangement (i.e., by performing step 306 before, or together with, step 304).

### Arrangement Optimization

For the Surface-17 code, simulated annealing is performed starting with the Naive qubit configuration shown in FIG. 4A. The minimal circuit depth reached is 8, which is 2 rounds away from the optimal depth. As discussed below, this depth is enough to achieve adequate error correction performance with the 2×N modules.

Out of all the possible qubit configurations which minimize the circuit depth, the configuration with the minimal number of shuttled 2-qubit gates is chosen, since these are expected to be the worst performing gates of the circuit. The optimal qubit arrangement for Surface-17 is obtained by minimizing over depth and subsequently over total number of shuttled 2-qubit gates as shown in FIG. 5.

### Syndrome Extraction

The syndrome of the code is determined, at step 308, by executing the SEC. FIG. 5 illustrates an exemplary syndrome extraction circuit 500 for the Surface-17 QECC. Quantum error correction is achieved over a series of one or more cycles, where the total number of cycles is given by the circuit depth of the arrangement. To complete one full quantum error correction cycle, the syndrome is extracted and then decoded to form the output recovery operator to project the qubits back to the code space.

In the described examples, the device 100 is configured to perform a cycle of the error correction on the L1 logical qubit (as represented by the QECC) of a 2×N array: (i) initializing one or more ancilla qubits of the QECC in the array according to the arrangement, as determined in step 304; (ii) performing one or more 2-qubit entangling gates, as determined in step 306, each gate entangling one or more pairs of spin qubits of the QECC; and (iii) measuring the ancilla qubits.

FIG. 6 illustrates the rounds of error correction for one cycle of the Surface-17 code using the desired arrangement of qubits, and where each circuit operation is explicitly shown on the 2×N array. The total number of rounds, i.e., the circuit depth, is 8 (2 away from the optimal achieved in an unconstrained 2D architecture). The initial and final rounds involve preparation and measurement of ancilla qubits, respectively.

In the first round, the ancilla qubits 9 to 16 are initialized in the respective basis of the stabilizer they are measuring. For example, ancilla 11 is initialized in the +1 eigenstate of the X basis, |+ [symbol] , as it will extract the measurement of the X-type stabilizer

$${S}_{1}^{x} = {X}_{0} {X}_{1} {X}_{3} {X}_{4} .$$

The middle rounds (2 to 7) involve entangling operations between the ancilla and data qubits. That is, the entangled qubits comprise a data qubit associated with a stabilizer of the QECC and one or more corresponding ancilla qubits of the QECC. The horizontal double arrows represent nearest neighbor 2-qubit gates and the arrows going through the empty holes on the top line of the array represent shuttled 2-qubit gates. With reference to FIG. 3B, the lines indicate the pairs of qubits to entangle. That is, ancilla qubit 11 is entangled with data qubits 0, 1, 3, and 4.

The final round of the circuit (8) consists of reading out the state of the ancilla qubit in the appropriate basis. For ancilla qubit 11, this is a measurement in the X basis. The observed reading of an ancilla qubit (±1) is assumed to correspond to the measurement outcome of the corresponding stabilizer.

FIG. 3B illustrates a generalized process for performing step 308 to achieve execution of the SEC^{2×N}( [symbol] ) of a particular QECC, [symbol] , once the scheduling of its constituent operations has been optimized in the 2×N array, using the methods of steps 304 and 306. For example, SEC^{2×N}( [symbol] ) for Surface-17 is shown in FIG. 6 as discussed above. At step 322, a pair of qubits is selected for entangling, the pair of entangled qubits comprising a data qubit associated with a stabilizer of the QECC and a corresponding ancilla qubit of the QECC. The pair of qubits are selected according to the gate scheduling and arrangement of steps 306 and 304.

The entangling operation is dependent on the relative locality of the qubits in the array 102. At step 323, a check is performed to determine whether the qubits are neighboring qubits. If so, then the qubits to be entangled already reside in neighboring dots, and entangling the qubits includes causing a direct local interaction between the qubits without shuttling either of the qubits. Otherwise, at step 324 entangling the pair of spin qubits comprises: shuttling a selected spin qubit of the pair of spin qubits from the first line of the array through the second line of the array, aligning the selected spin qubit with the other spin qubit, performing a 2-qubit gate, and then shuttling at least the selected spin qubit back to the first line of the array.

At step 328, the entangling operations are completed and a 2-qubit gate is formed between the spin qubits of the selected pair. Repeating the process for at least one non-neighboring pair of spin qubits results in the coherent transportation of spin qubits within the array as a means by which quantum information is relayed between remotely located positions in the array.

### Decoding and Recovery

With reference to FIG. 3A, following the syndrome extraction process of step 308 decoding is performed at step 310 to map the syndrome of the code SEC^{2×N}( [symbol] ) to a recovery operator, [symbol] :S→ [symbol] . The recovery operator specifies Pauli operations to apply to the physical qubits of the code,

$$𝒟 ( S ( ε ) ) = {⊗}_{i = 0}^{8} {R}_{i}$$

where R∈{X,Y,Z}, and it serves two purposes: (1) returns the code to the code space (i.e., after applying it, every stabilizer returns a +1 reading); and (2) returning the code to the original logical subspace (i.e., to avoid creating strings of Pauli errors by selecting the least weight correction operator consistent with the observed syndrome).

The recovery operator determined for the syndrome SEC^{2×N}( [symbol] ) may vary according to the decoding process. Possible recovery operators for

$$S ( ε ) = \{ {S}_{1}^{x} \}$$

include

$$ℛ = 𝒟 \{ {S}_{1}^{x} \} = {Z}_{0} or {Z}_{3} .$$

Both return the initial code state (Z₀ε|ψ̅ [symbol] =Z₀Z₀|ψ̅ [symbol] =|ψ̅ [symbol] and Z₃ε|ψ̅ [symbol] =Z₃Z₀|ψ̅ [symbol] =|ψ̅ [symbol] , since

$${Z}_{3} {Z}_{0} = {S}_{1}^{z}$$

is a stabilizer, and |ψ̅ [symbol] is in the +1 eigenspace of all stabilizers), and to the same initial logical subspace (there are no remnant strings of errors connecting opposite boundaries).

The implementation of a decoder is related to the number of stabilizer generators of the QECC. For example, Surface-17 has only 4 X-type stabilizers,

$$( {S}_{i}^{x} ) i ∈ \{ 1 , 2 , 3 , 4 \} ,$$

and 4 Z-type stabilizers,

$$( {S}_{i}^{z} ) i ∈ \{ 1 , 2 , 3 , 4 \} .$$

Furthermore, the X and Z stabilizers can be treated separately where the X (Z) stabilizers, S^{x} (S^{z}), flag an odd number of Z (X) errors on their support, from which we can obtain a recovery operator composed entirely out of Z (X) errors.

In one example, due to the small number of stabilizers of the code, decoding is performed via decoder map that specifies [symbol] :S→ [symbol] explicitly. That is, the decoder map associates a recovery operator with each possible observed X-syndrome (top) and Z-syndrome (bottom), as individually determined by finding the optimal correction operator for each observed syndrome. This is known as exact maximum-likelihood decoding. For example, for an observed the syndrome

$$S = \{ {S}_{1}^{x} , {S}_{2}^{x} , {S}_{2}^{z} \} = \{ {S}_{1}^{x} , {S}_{2}^{x} \} ⋃ \{ {S}_{2}^{z} \} ≡ {S}^{z} ⋃ {S}^{z} ,$$

the a lookup operation is performed on the decoder map to retrieve a recovery operator:

$$ℛ = 𝒟 ( S ) = 𝒟 ( {S}^{x} ⋃ {S}^{z} ) = {R}^{x} ◦ {R}^{z} = {Z}_{1} ◦ {X}_{2} .$$

At step 312, the recovery operator Z₁X₂ is applied to the code, returning it to the code space. In some embodiments, the syndrome decoding operations are performed by a classical computing processor device (e.g., using binary data as +1 or −1) and using classical algorithms. The classical processor may be configured to receive information from the quantum processor 100 (e.g., the syndrome value) via an electrical connection means (e.g., hardwiring). In such embodiments, the classical processor operates as a decoding device in communication with the quantum processor 100 and related components. This is advantageous in that decoding can be performed off-chip, relative to the quantum processor 100, while still achieving sufficiently fast computation to avoid spin qubit decoherence. The above-described table based decoder runs in constant time O(1) and therefore is practical to implement with current classical technology.

### Fault-Tolerant Circuit Extraction

Error correction for a code of distance d is fault-tolerant if a single error, on any component of the circuit, propagates to at most

$$⌊ \frac{d - 1}{2} ⌋$$

errors on the qubits of the code. Since a code of distance d tolerates up to

$$⌊ \frac{d - 1}{2} ⌋$$

errors, fault-tolerance requires that errors introduced by the error correction circuit do not lead to an uncorrectable error. A circuit that is not fault-tolerant has limited practical use since its mere execution can corrupt the logical qubit stored in the code. That is, performing practical quantum error correction involves addressing errors introduced from the environment and also from the gates used to design the correction protocols.

For the distance d=3 codes of the examples described herein, fault-tolerance d-1 requires that a single-error event in the SEC leads to at most 1 output error

$$( ⌊ \frac{d - 1}{2} ⌋ = 1 ) .$$

The original SEC for Surface-17 was designed to be able to tolerate single-error events on any of the one-qubit and two-qubit gates of the circuit as well as during initialisation.

An example of an error which damages the stored logical qubit is ε′=Z₀Z₁. This error leads only to stabilizer

$${S}_{2}^{x} = {X}_{1} {X}_{2}$$

flagging an odd number of errors around it,

$$S ( {ε}^{′} ) = \{ {S}_{2}^{x} \} .$$

The least weight correction to such observed syndrome is

$$ℛ = 𝒟 \{ {S}_{2}^{x} \} = {Z}_{2} .$$

Once Z₂ is applied, the state returns to the code space, but now there is a string of Z operators remaining on the code (Z₀Z₁Z₂), which is equivalent to a logical phase-flip (Z̅|ψ̅ [symbol] ). Such an error is undetectable by measuring the stabilizers (indeed it is part of the code space, by construction). This is an example of a logical error.

Fault-tolerance is achieved by ordering the 2-qubit entangling gates in a particular way. For Surface-17, the 2-qubit gates of the SEC 500, as depicted in FIG. 5, are ordered in a way that propagate single-qubit errors into two-qubit errors. This is an inevitable property of a 2-qubit gate, but where only 1 of the 2 propagated errors are aligned along the direction of the logical operator. Therefore, the effective output number of errors, aligned in the direction which can cause a logical failure is 1, satisfying fault-tolerance. Since the optimization of operations in the 2×N array schedules the operations in different rounds, and does not change their relative order, fault-tolerance is preserved for one-qubit and two-qubit gate errors when executing the SEC in the 2×N array.

Fault-tolerance to measurement errors requires the ability to detect if one of the ancilla qubits was read off incorrectly. For example, if a reading of the qubit gave a −1 instead of the correct +1. Measurement errors can be tolerated, provided they are of sufficiently low strength, by repeating the stabilizer measurements. This repetition of the circuit execution is performed only if the initial SEC does not return a trivial syndrome (that is, one where every stabilizer gives a +1 reading, S={Ø}), and provide protection against measurement errors.

The final output of the SEC for the codes, after accounting for fault-tolerance, is the syndrome of the code. That is, the list of stabilizers which return a −1 measurement outcome:

$$S = \{ {S}_{{i}_{1}}^{x} , {S}_{{i}_{2}}^{x} , … , {S}_{{j}_{1}}^{z} , {S}_{{j}_{2}}^{z} , … \} .$$

### Other Quantum Error Correction Codes

In other embodiments, quantum error correction is performed with a QECC other than the Surface-17 code. For example, processor 100 may apply a QECC such as a Shor code (e.g., Shor6X2Z and Shor6Z2X; see Debroy [6]), the Bacon-Shor-13 code (see Bacon [7]), or the XZZX-17 surface code (see Bonilla Ataides [8]). All of these codes are distance d=3 and require no more than 20 physical qubits to implement. The properties of the syndrome extraction circuits of the above QECCs, when executed in the 2×N arrays, are provided below:

| | | Circuit | 2-qubit | |
|---|---|---|---|---|
| Code | Qubits | depth | gates | Shuttled |
| Bacon-Shor-13 | 13 | 13 | 24 | 12 |
| Surface-17 | 17 | 8 | 24 | 8 |
| Shor6X2Z | 17 | 10 | 24 | 9 |
| Shor6Z2X | 17 | 10 | 24 | 9 |
| XZZX-17 | 17 | 8 | 24 | 8 |

‘Qubits’ is the total number of physical spin qubits required by each scheme, ‘Circuit depth’ is the depth of the syndrome extraction circuit when executed in the bilinear array, ‘2-qubit gates’ is the number of 2-qubit gates used by the circuit, and ‘Shuttled’ is the number of shuttled 2-qubit gates required by the circuit.

The SECs of these codes are fault-tolerant and only require measurement of the ancilla qubits at the end of the error correction round. This reduces the demand on measurement with spin qubits, which is a slow operation. In described embodiments, the error-correction circuit is pre-determined and remains fixed throughout the full quantum error correction cycle. In some embodiments, the execution of different parts of the circuit is conditioned on the measurement outcome of a flag qubit.

### Error Correction Performance Evaluation

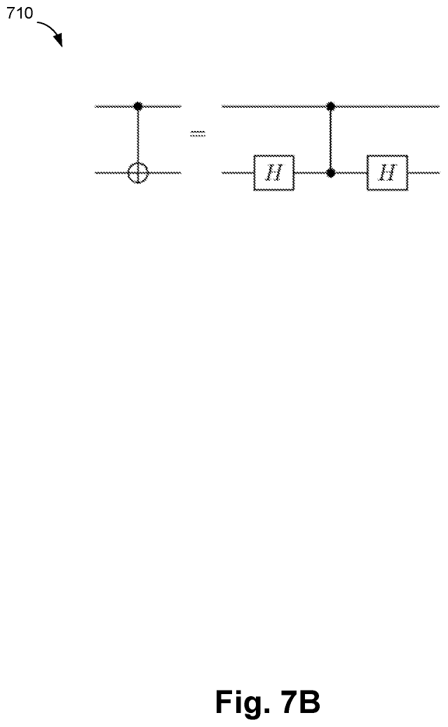

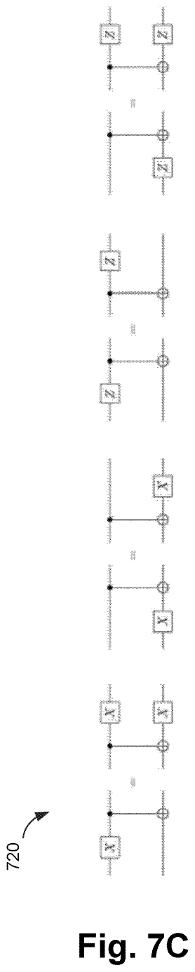

Monte Carlo simulations are performed to evaluate the failure rate of the L1 logical qubits stored in the 2×N arrays of processor 100 according to the method 300 proposed above. FIG. 7A illustrates a simulation model 700 used to assess the performance of error correction in the 2×N array of SiMOS quantum dots. First, a QECC is chosen, [symbol] , and its syndrome extraction circuit is broken down to fit in the 2×N array in an optimal way (using the methods described above). Errors are modelled during every operation of the circuit according to an externally injected error model, E.

The syndrome extraction circuit, SEC^{2×N}( [symbol] ), is repeated conditioned on the measurement outcome of the ancilla qubits being non-trivial, in order to account for measurement errors. The final output of the circuit is the syndrome, S, which passes through a decoder, [symbol] , to form a recovery operator, [symbol] . The latter is applied back to the code, and the recovered code state is checked to determine whether it registers a logical failure (i.e., a failure on the stored logical qubit of the code). Various aspects of the evaluation are described below.

### Error Modelling

Error events are modelled during initialization, single-qubit gates, two-qubit gates, shuttling, measurement and idling of the qubits. The native operations used in the syndrome extraction circuits and the associated errors modelled for each are shown below.

| Operation | Error rate | Structure |
|---|---|---|
| CZ | p_{2q} = p | p_{ZZ} = 1 |
| H | p_{1q} = p/10 | p_{X} = p_{Y} = p_{Z} = ⅓ |
| [symbol] | pᵢ = p | Error in Assignment |
| [symbol] | pₘ = p | Error in Assignment |
| Idling | p_{Idl} = p/10 | p_{Z} = η/(1 + η), p_{X} = p_{Y} = ½(1 + η), |
| | | η = 1000 |
| One-off | p_{Sthl} = 0.6 p | p_{Z} = η/(1 + η), p_{X} = p_{Y} = ½(1 + η), |
| shuttling | | η = 10 |
| Exponential | p_{Sth1} = 3.5 p | p_{Z} = η/(1 + η), p_{X} = p_{Y} = ½(1 + η), |
| shuttling | | η = 10 |

‘Operation’ is the native operation used in the extraction circuits. ‘Error rate’ is the probability of an error occurring on that operation during any given round. These error rates are given as a multiple of the 2-qubit error rate, p. ‘Structure’ is the type of errors that are modelled after each operation, provided that an error occurs in the first place.

### 1. Two-Qubit Gates: CNOT and CZ

CZ gates are native to the physical architecture and are executed directly by tampering with the exchange interaction. FIG. 7B illustrates a circuit identity 710 representing an implementation of a CNOT gate based on a combination of a CZ gate and 2 Hadamard gates.

The error correction circuits mainly use the CNOT gate, and occasionally the CZ gate. The fidelity of CNOT and CZ are comparable, since they can be related to each other by 2 Hadamard gates, which are an order of magnitude higher-fidelity than the 2-qubit gates. As such, defining the general 2-qubit error rate as p_{2q}:

$$p := {p}_{CNOT} \approx {p}_{CZ} ∼ 1 \% \qquad ( 1 )$$

The dominant error proceeding a CZ gate is ZZ. The appropriate error channel used in the simulations is:

$${ε}_{c z} ( ρ ) = ( 1 - p ) II + p ( ZZ ρ ZZ )$$

A CZ gate can be executed in t_{CZ}~0.1 μs. Since Hadamard gates take t_{H}~1 μs, then the time required to execute a CNOT gate is dominated by the time required to execute the Hadamard gates: t_{CNOT}~2 μs.

### 2. Single Qubit Gate

The discussion is focused on the Hadamard gate, H, since it is the main single-qubit gate used in the circuits. The fidelity of this gate is approximately a factor of 10 greater than the fidelity of two qubit gates:

$${p}_{1 q} ∼ \frac{p}{10} \qquad ( 2 )$$

For single-qubit gates, a depolarising Pauli channel is used, where X, Y and Z errors occur with the same rate:

$${ε}_{H} ( ρ ) = ( 1 - {p}_{1 q} ) I + \frac{{p}_{1 q}}{3} ( X ρ X + Y ρ Y + Z ρ Z )$$

The time required to execute single-qubit gates is t_{1q}~1 μs.

### 3. Initialization and Measurement

In the evaluation examples, the fidelities of initialization and measurement are comparable since they are linked processes, and are each approximately equal to the fidelity of a 2-qubit gate. Letting the error rate of initialization and measurement be pᵢ and pₘ, respectively:

$${p}_{i} = {p}_{m} = p \qquad ( 3 )$$

Both initialization and measurement are modelled as an error in assignment. For example, for the preparation of states |0 [symbol] (resp. |+ [symbol] ), then there is an erroneous preparation of the states |1 [symbol] (resp. |− [symbol] ) with probability pᵢ. Similarly, if the measurement outcome is expected to be +1 (resp. −1) then the output the measurement outcome is −1 (resp. +1) with probability pₘ.

Initialization is assumed to involve moving in the qubits from a reservoir placed on the left side of the array and measurement to involve moving the qubits out of the array toward the right. Under this assumption then the effective time for initialization and measurement (i.e., how long the other qubits will be idle for) will be equal to the total time required to shuttle the qubits in and out of the array. For a code which requires N total qubits, this time will be:

$${t}_{i} = {t}_{m} = ( N + 1 ) {t}_{d} - 2 ns = 0.0 \; 02 μs$$

For the evaluated codes, N~20 is used, where t_{d}~0.1 ns is the time required to shuttle over one dot. This is assuming that the actual measurement of the ancilla qubits, which will take a much longer time, can be performed separately and is not required until the very end of the circuit.

In other examples, knowledge of the measurement outcome of ancillas may be required before proceeding with the quantum error correction cycle (e.g., for flag-based error correction), in which case the initialization time remains the same, but the measurement time will be

$${t}_{m}^{′} - 100 μs .$$

### 4. Shuttling

The evaluations account for two possible models of shuttling over multiple dots. In the first model, the dominant error comes from a one-off cost needed to get the spin moving and then is largely independent of the number of dots traversed. In the second model, errors accumulate exponentially after each dot jump. Letting f_{d} be the fidelity of shuttling over a single dot, the error rates associated with moving over n dots in the exponential shuttling model and in the one-off cost model are:

$${p}_{s h t 1}^{†} ( n ) = 1 - {f}_{d}^{n} , {p}_{Sht 1}^{*} ( n ) = 1 - {f}_{d} , \qquad ( 4 )$$

respectively. Based on experimental results for shuttling over a single (see Yoneda [4]), f_{d}=99.4%. For these, the number of shuttled dots for any 2-qubit gate is rarely larger than 6 and this number is therefore taken as a pessimistic representation of a general shuttled 2-qubit gate. Then,

$${p}_{S h t 1}^{†} ( 6 ) = 1 - {f}_{d}^{6} ∼ 3.5 p , and {p}_{Sht 1}^{*} = 1 - {f}_{d} ∼ 0.6 p \qquad ( 6 )$$

represents shuttling within a single 2×N module:

$${p}_{S h t 1}^{†} ∼ 3.5 p , {p}_{Sht 1}^{*} ∼ 0.6 p \qquad ( 5 )$$

With either shuttling model, the qubit that is being shuttled will experience predominantly dephasing errors. The noise bias is quantified through the coefficient:

$$η = \frac{{p}_{Z}}{{p}_{X} + {p}_{Y}}$$

which indicates how much more frequently Z errors occur compared to X and Y errors. The bias coefficient associated with shuttling is η~10. The Pauli error channel used to describe errors during shuttling then becomes:

$$ℰ ( ρ ) = ( 1 - {p}_{Sht 1} ) I + {p}_{h . r .} Z ρ Z + {p}_{l . r .} ( X ρ X + Y ρ Y ) \qquad ( 6 )$$

where p_{h.r.}=p_{Shtl}η/(1+η) and p_{l.r.}=p_{Shtl}/2(1+η), and h.r. and l.r. stand for high rate and low rate, respectively.

The per-dot shuttling time is t_{d}=0.1 ns. The time for a shuttled 2-qubit gate over n dots equals the shuttling time plus the time required to execute the 2-qubit gate. Since shuttling is orders of magnitude faster than the two-qubit gate, the time of a shuttled 2-qubit gate is largely given by the time of the 2-qubit gate, t_{2q}.

### 5. Idling

The fidelity of an idling qubit is modelled as an exponential decay with lifetime constant given by the computational time, T₂. Defining p_{Idl}(t) as the probability of an error on an idling qubit over a time period of t:

$${p}_{Idl} ( t ) = 1 - {e}^{- \frac{t}{{T}_{2}}} \qquad ( 7 )$$

T₂ can be as long as 2 ms, experimentally achieved by continuously and resonantly driving the spin qubit with an external field (see Hansen [9]). Although T₂ is expected to increase in the future, T₂=2 ms is taken as a current estimate of what can be achieved with spin qubits.

A general error rate is assigned to idling as a multiple of the 2-qubit error rate, p. For a conservative estimate, the idling error rate during the longest round of the syndrome extraction circuit is used. This is the round where the CNOT gate is implemented (which is the longest 2-qubit gate used in the circuit), where the time is given by t_{CNOT}~2 μs. To first order, shuttling will not affect the two-qubit gate times since it is very fast (0.1 ns per dot), and shuttling rarely occurs over distances greater than 6 dots. Then, the time of the longest round, irrespective of whether the 2-qubit gates are shuttled or not, is ~2 μs, and the associated idling error rate is: p_{Idl}(2 μs)=1−e^{-2 μs/2000 μs}~p/10. This general expression is used to model idling errors on every qubit not undergoing an operation during each round of the extraction circuit:

$${p}_{Idl} - \frac{p}{10} . \qquad ( 8 )$$

Idling noise is also dominated by dephasing. The appropriate bias coefficient for our physical implementation of spin qubits is q=1000, where the same error channel as Equation (6).

### Circuit Noise Simulations

The error model is used to simulate noise on every operation of the error correction circuits, including during idling. The SEC^{2×N}( [symbol] ) is executed with the error model according to the following steps: [symbol]
(i) Execute operation of the circuit;
(ii) Propagate the current error state through the operation (e.g. through the gate); and
(iii) Introduce new errors associated with that operation, as specified by the error model, and group with the propagated error.

The way that Pauli errors propagate through gates of the circuit depends on the explicit quantum operation that the gate performs. FIG. 7C illustrates the propagation of Pauli errors in CNOT gates according to one example configuration of gates 720. Pauli Y errors can be broken down into a Pauli X error and a Pauli Z error, and these can be propagated separately.

Knowledge of how errors are introduced and propagated through the syndrome extraction circuit completes the full description of the circuit noise simulations. These errors spread to the qubits of the code, and it is the role of the decoder (e.g., as described above for the look-up decoder) to find a suitable recovery operator based on the extracted syndrome. A check is performed to determine if physical errors have accumulated to damage the stored logical qubit in the code. An exemplary process of performing this type of logical state diagnosis is described below.

### Logical State Diagnosis

The logical state of the QECC is verified after a round of quantum error correction to determine if the recovered state, |φ̅ [symbol] =( [symbol] ε)|ψ̅ [symbol] , encodes the same logical information as the initial state, |ψ̅ [symbol] , or if a logical error has occurred. The error state of the code ε|ψ̅ [symbol] is determined as a binary vector: e=(x₁, . . . , xₙ|z₁, . . . , zₙ) where xᵢ(zᵢ) equals +1 if there is an X (Z) error on qubit i, or 0 otherwise.

The total number of data qubits of the code is n=9 for Surface-17. The recovery operator, [symbol] , is applied to the error state of the code and yields the recovered state. The recovery operator is given in binary vector form as: φ=(r⊕e), where ⊕ is binary XOR, which corresponds to addition modulo 2. The stabilizers of the code can be expressed in the same binary vector format, and stacked row by row to form a matrix, S_{M}. A similar expression is possible for the logical operators of the code, to form the matrix L_{M}. For Surface-17, these become:

$${S}_{M} = ( \begin{matrix}{S}_{1}^{x} \\ {S}_{2}^{x} \\ {S}_{3}^{x} \\ {S}_{4}^{x} \\ {S}_{1}^{z} \\ {S}_{2}^{z} \\ {S}_{3}^{z} \\ {S}_{4}^{z}\end{matrix} ) = ( \begin{matrix}{X}_{0} {X}_{1} {X}_{3} {X}_{4} \\ {X}_{1} {X}_{2} \\ {X}_{4} {X}_{5} {X}_{7} {X}_{8} \\ {X}_{6} {X}_{7} \\ {Z}_{0} {Z}_{3} \\ {Z}_{1} {Z}_{2} {Z}_{4} {Z}_{5} \\ {Z}_{3} {Z}_{4} {Z}_{6} {Z}_{7} \\ {Z}_{5} {Z}_{8}\end{matrix} ) = ( \begin{matrix}1 & 1 & 0 & 1 & 1 & 0 & 0 & 0 & 0 \\ 0 & 1 & 1 & 0 & 0 & 0 & 0 & 0 & 0 \\ 0 & 0 & 0 & 0 & 1 & 1 & 0 & 1 & 1 \\ 0 & 0 & 0 & 0 & 0 & 0 & 1 & 1 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0\end{matrix} \vert \begin{matrix}0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 1 & 0 & 0 & 1 & 0 & 0 & 0 & 0 & 0 \\ 0 & 1 & 1 & 0 & 1 & 1 & 0 & 0 & 0 \\ 0 & 0 & 0 & 1 & 1 & 0 & 1 & 1 & 0 \\ 0 & 0 & 0 & 0 & 0 & 1 & 0 & 0 & 1\end{matrix} ) , and$$

$${L}_{M} = ( \begin{matrix}\overline{X} \\ \overline{Z}\end{matrix} ) = ( \begin{matrix}{X}_{0} {X}_{3} {X}_{6} \\ {Z}_{0} {Z}_{1} {Z}_{2}\end{matrix} ) = ( \begin{matrix}1 & 0 & 0 & 1 & 0 & 0 & 1 & 0 & 0 \\ 0 & 0 & 0 & 0 & 0 & 0 & 0 & 0 & 0\end{matrix} \vert \begin{matrix}0 & 0 & 0 & 0 & 0 & 0 & 0 & 0 & 0 \\ 1 & 1 & 1 & 0 & 0 & 0 & 0 & 0 & 0\end{matrix} ) .$$

Then, perform the operation:

$$ϕ ⊙ {L}_{M}^{t} = ϕ ( \begin{matrix}0 & {I}_{n \times n} \\ {I}_{n \times n} & 0\end{matrix} ) {L}_{M}^{t} ( mod 2 ) ≡ ( \begin{matrix}\overline{x} & \overline{z}\end{matrix} )$$

where

$${L}_{M}^{t}$$

is the transpose of matrix L_{M} and ⊙ is known as the binary symplectic product. The output is the binary 1×2 vector (x̅ z̅). x̅(z̅) equals +1 if the code state anti-commutes with logical Z̅ (X̅), and equals 0 otherwise. Since X̅ and Z̅ anti-commute, this means that:

$$\overline{x} = \{ \begin{matrix}+ 1 & if logical \overline{X} failure \\ 0 & if no logical \overline{X} failure\end{matrix}$$

$$\overline{z} = \{ \begin{matrix}+ 1 & if logical \overline{Z} failure \\ 0 & if no logical \overline{Z} failure\end{matrix}$$

For example, if there was a logical X failure in the code (|φ̅ [symbol] =X̅|ψ̅ [symbol] ), then the code state would anti-commute with logical Z̅ (Z̅X̅=(−1)X̅Z̅), and the output x̅=+1 (by definition of x̅) occurs, which according to the rules set up above, correctly establishes the presence of a logical X̅ error.

### Performance Assessment

The performance of error correction in a 2×N array is assessed for the aforementioned 5 QECCs where each are applied to protect the L1 logical qubit stored in the 2×N modules. The error model described above is applied where every error source is given as a multiple of a single parameter, p, which quantifies the strength of the noise.

The simulations take as an input a QECC and the associated syndrome extraction circuit in the 2×N array, expressed as SEC^{2×N}( [symbol] ), and produce as an output either ‘1’ if the stored logical qubit failed or ‘0’ if it remains intact. The logical failure rate P of the stored qubit is assessed by conducting Nm simulations, and observing F logical failures. There is uncertainty in the estimation (the standard deviation), σP, as given by the Monte Carlo estimates:

$$\overline{P} = \frac{F}{{N}_{m}} , σ \overline{P} = \sqrt{\frac{\overline{P} ( 1 - \overline{P} )}{{N}_{m}}}$$

Roughly, a QECC in the 2×N module is good if the failure rate of the encoded logical qubit in the module, P̅, is low. There is, however, a more encompassing figure of merit to assess the performance of small codes—the pseudothreshold. The pseudothreshold is the physical failure rate, pₚₜₕ, below which the failure rate of the encoded logical qubit, P̅, drops below the failure rate of the unencoded, bare physical qubit, P_{unenc.}. That is, for p<pₚₜₕ, we have P̅<P̅_{unenc}.

Therefore, an error correction scheme with a pseudothreshold of pₚₜₕ will only afford successful protection to a qubit (i.e., decrease the qubit's error rate from its current value) if the physical noise on that qubit is small enough (below pₚₜₕ). If the noise on the qubit is higher than pₚₜₕ, then encoding the qubit with the QECC becomes detrimental, rather than favorable, making the qubit fail at a higher rate than if it was left bare (unencoded). Effective error correction, therefore, typically exhibits high pseudothresholds, so that they may offer protection to a larger number of noisy qubits.

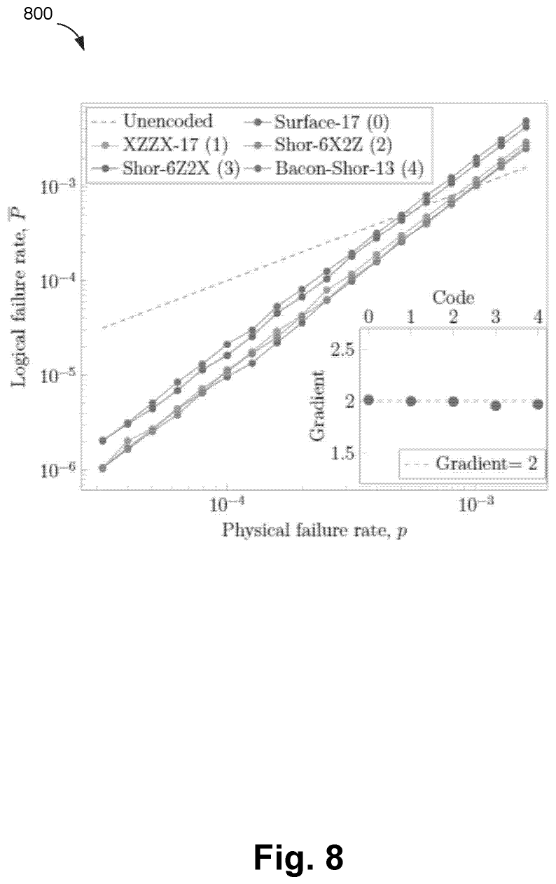

FIG. 8 shows the performance (i.e., logical failure rate) of the QECC for L1 logical qubits encoded in the 2×N module, when using the 5 different QECCs and the single-off error model for shuttling. The pseudothreshold corresponds to the x-axis value (i.e. the physical failure rate) of the crossing between the failure rate of the encoded qubit and the failure rate of an unencoded, bare, physical qubit (P̅=p)—the red dashed line. The 5 QECCs have been labelled from 0 to 4 as indicated in the legend. The inset plot shows the gradient of the best-fit lines to all of the logical failure curves. The gradient equals 2 in agreement with our understanding of fault-tolerance and the error correction capabilities of distance d=3 codes. Error bars for all data points are smaller than the size of the markers used.

The crossing point between the logical failure curves for different codes and the dashed line characterizes the pseudothreshold of each code, pₚₜₕ. For physical error rates p<pₚₜₕ, the logical failure rate of a qubit encoded with that code drops below that of an unencoded, bare physical qubit. The table below presents the exact values of the pseudothresholds for the different codes used and for each of the two shuttling error models evaluated (i.e., single-off and exponential accumulation of errors).

| | | | Exponential | |
|---|---|---|---|---|
| | Single-off shuttling | | accumulation shuttling | |
| | Pseudothreshold | Logical | Pseudothreshold | Logical |
| Code | (×10⁻⁴) | bias | (×10⁻⁴) | bias |
| Surface-17 | 9.8 | 23 | 2.8 | 40 |
| Shor-6X2Z | 9.5 | 15 | 4.0 | 10 |
| Shor-6Z2X | 5.7 | 17 | 1.4 | 13 |
| XZZX-17 | 8.4 | 0.89 | 2.2 | 1.0 |
| Bacon-Shor-13 | 5.0 | 20 | 1.3 | 13 |

The observed linear trend and the parallel nature of the lines in FIG. 8 may be explained as follows. At the low p values sampling occurs from (p~10⁻⁴-10⁻³ (see the x-axis values of FIG. 5) and very few errors are introduced to the code per simulation run. Therefore, logical failures are due in practice to the lowest weight error configurations that cannot be corrected by the underlying code. Since all the codes are of distance d=3, they can successfully correct all weight

$$⌊ \frac{d - 1}{2} ⌋ = 1$$

errors. Single error events could still lead to logical failure if they cascaded to higher weight errors through the extraction circuit. However, this is prevented since all the circuits are fault-tolerant meaning that weight-1 errors can propagate to errors of weight at most 1.

The next most likely number of errors that can lead to failure are therefore double-error events. Two errors conspiring in a line can lead to logical failure. The logical failure rate is therefore, at the low p values sampled from, to be dominated by weight-2 errors. Since each error occurs with a probability p, the logical failure rate caused by these double-error events is given by: P̅~p×p=p²⇒log P̅~2 log p. In a log-log plot of P̅ vs. p all codes are straight lines with a gradient of 2. The inset plot of FIG. 8 demonstrates that the gradient of the best-fit line to each of the codes' failure rate curves equals to 2. This is consistent with how fault-tolerance is preserved when the syndrome extraction circuits is executed on the 2×N array.

In the case of one-off shuttling errors, the pseudothreshold is as large as p~O(10⁻³). In the case where shuttling errors compound exponentially the pseudothresholds still reach up to 4×10⁻⁴ (Shor-6X2Z). The physical failure rate used in the error correction simulations is equal to the 2-qubit gate error rate, p=p_{2q} (as shown above). Therefore, a pseudothreshold of p=10⁻³ demands a 2-qubit gate fidelity of 99.9% in order for error correction to be successful.

It is desired to use the QECCs to significantly suppress the error rate of the stored logical qubit compared to an unencoded qubit. FIG. 8 shows that at p=10⁻⁴ the error rate for most of the QECCs is around P̅~10⁻⁵. This sets a target on spin qubit fidelities necessary to achieve an order of magnitude error suppression using our QECCs.

Another metric of interest is the ability of the codes to preserve the bias of the noise at the logical level (degree of “logical bias”). This ensures that the encoded L1 logical qubit can be used for further QEEC (as discussed below). The tabulated results show the logical bias of the noise for each code, which is defined as the rate of logical Z errors over the rate of logical X and Y errors:

$$\overline{η} = \frac{\overline{Z}}{\overline{X} + \overline{Y}} .$$

Surface-17 is the code which preserves the noise bias to the largest extent. This can be attributed to the symmetric layout of its stabilizers and logical operators, and the fact that X and Z stabilizers and logical operators are disjoint (it is a CSS code). On the other hand, the XZZX surface code has stabilizers and logical operators which contain a mix of X and Z operators. As such, a high rate of physical Z errors contributes to both logical X and logical Z failures, which explains the low logical bias observed for the XZZX code.

Based on these results, the techniques proposed above provide a general framework to break down the error correction circuit of any QECC to fit within the geometric constraints of a bilinear 2×N array of quantum dots. That is, should another code of interest arise in the future, it can be subject to the methods presented above and assessed according to the metrics of this section to analyze its error correction capabilities relative to the other codes.

Scalable Quantum Processing with Fault Tolerance

Scalable quantum error correction requires the error rate of the processing qubits to be reduced to approximately ~10⁻¹⁵ for executing useful quantum algorithms. The approaches described above protect a plurality of spin qubits as a L1 logical qubit in a bilinear array. Fault tolerance is achieved by performing an identity gate on the L1 logical qubit, with a high pseudothreshold of ~10⁻³. However, it is difficult to practically realize the desired error rate in the first level (L1) logical qubits. This is because extending the number N of physical qubits, as required to increase the distance of the QECC, increases the distance over which the qubits are shuttled which curtails the protection provided by the error correction strategy.

It is desired to utilize the encoding of the L1 logical qubits in the 2×N arrays, performed according to a first-level QECC as described above, as high-quality qubits in an architecture that provides fault tolerance while enabling scalability of the error protection. The proposed techniques provide scalable quantum error protection by connecting a plurality of 2×N arrays, such that a second level of qubit encoding can be implemented from a number M>1 of the L1 logical qubits. The encoding applied to second level (L2) logical qubits can be expanded in order to achieve arbitrarily well protected logical qubits. Described below is an approach to (i) coupling a plurality 2×N quantum dot arrays, and (ii) implementing a fault tolerant quantum operation set with the coupled arrays, thereby enabling treatment of the L1 qubit as a “base qubit” on which further (second level) error protection can be applied.

### Coupling Multiple 2×N Arrays

FIG. 1C schematically illustrates part of a quantum processor 100 which has a plurality of bilinear arrays of quantum dots 102a, 102b, 102c, 102d, where the arrays are arranged in a grid disposed between control circuitry portions 110a, 110b, 110c. The control circuitry portions 110a, 110b, 110c each include readout and control electronics that collectively constitute, or form part of, a controller 110 of the quantum processor 100. The controller 110 is configured to control the operation of the quantum processor 100 at least by selectively coupling, via a coherent coupling mechanism, a first L1 logical qubit of a first bilinear array to a second L1 logical qubit of a second bilinear array, wherein the coupling occurs by long range interaction based transportation of the information encoded by the first L1 qubit into the second L1 qubit. On this basis, the controller 110 is configured to perform one or more fault tolerant quantum processing operations on the L1 logical qubits of the plurality of bilinear arrays 102a-102d.

In the described embodiments, the coherent coupling mechanism includes a quantum transportation structure 150 configured to connect the plurality of bilinear arrays according to the architecture. With reference to FIG. 1c, the plurality of 2×N quantum dot arrays 102a, 102b, 102c, 102d are connected by a plurality of shuttling arrays 150a-150j of the quantum transportation structure 150. Each shuttling array 150a-150j includes one or more quantum dots arranged in a linear structure extending horizontally or vertically, relative to the orientation of the bilinear arrays, along a primary dimension. In the embodiment shown in FIG. 1c, horizontally oriented shuttling array sections 150a, 150b, 150c, 150d, 150g, 150h, 150i, 150j connect directly to the ends of respective bilinear arrays 102a, 102b, 102c, 102d, while vertically oriented arrays 150e, 150e form intersections with the horizontal sections.

In the described embodiments, each of the shuttling arrays 150a-150j spans a single quantum dot in the secondary dimension, as shown in FIG. 1C, to form a 1×D array. That is, the primary dimension D of the shutting array sections is scalable to connect the bilinear arrays 102a, 102b, 102c, 102d in the grid layout. In some embodiments, the shuttling arrays 150a-150j are configured with a secondary dimension greater than one (e.g., as 2×D arrays, 3×D arrays, etc.) to provide redundancy in the shuttling capability for transporting qubits between respective bilinear arrays 102a 102b 102c 102d.

FIG. 1D illustrates an exemplary layout of the quantum processor 100 of FIG. 1C where a plurality of bilinear arrays are organized according to the architecture depicted by FIG. 1c. Bilinear arrays, such as array 102a, are connected in a grid by shuttling gate arrays in vertical and horizontal directions. Sparse placement of the bilinear arrays allows for interspersing of readout and control electronics required for implementing integrated control of the arrays as L1 qubits.

The geometry of the layout depicted in FIG. 1D is advantageous in that it enables the gates that accumulate the quantum dots to have a fan out region, and while also accommodating the placement of the control and measurement electronics. For example, gates may be densely packed along the one-dimensional channel defined by the shuttling arrays but remain in contact with three-dimensional metal layers having a more relaxed pitch between interconnects.

As shown in FIG. 1D, each 2×17 bilinear array (e.g., 102a, 102b, etc.) is configured to implement the distance-17 surface code by coherently shuttling qubits across the shuttling line 107 to facilitate long-range 2-qubit interactions. In the example of FIG. 1D, the qubits of each bilinear array are confined within an active silicon layer (nanowire) underneath a plurality of plunger gates. A plurality of barrier gates are used to control interactions between qubits of the bilinear array as well as assist with the shuttling process. This enables each bilinear array to be operated as a L1 logical qubit as described herein.

The readout and control electronics circuitry is collectively configured to selectively couple the first L1 logical qubits and second L1 logical qubits by the coherent transportation of one or more spin qubits between the first bilinear array (102a,102b) and the second bilinear array (102c,102d) connected to the first array. The selective coupling of L1 logical qubits occurs by the creation of entangling operations between one or more of the spin qubits of each array of the L1 logical qubits, as described below in the context of performing quantum processing operations on the L1 qubits.

FIGS. 1E and 1F illustrate a means of qubit control and coherent transportation of qubits respectively for the quantum processor 100 of FIG. 1D. Qubit control is achieved through applying an oscillating electromagnetic field 160 in order to rotate the qubit spin vector 161. Two qubit coupling is achieved through applying a pulse 162 to one or more barrier gates to bring the qubits into close proximity for an exchange interaction. With reference to FIG. 1F, for interacting logical L1 qubits, the qubit array 102b of one L1 qubit can be shuttled to the shuttling line 107 of another L1 qubit 102a in order to carry out a concatenated error correction code and create an L2 logical qubit.

In other embodiments, the quantum transportation structure 150 may take a different form which may vary according to the layout of the bilinear arrays and/or other components of the quantum processor. For example, structure 150 may include one or more quantum buses or pipelines configured to physically connect one or more of the bilinear arrays of the processor. In some embodiments, the structure 150 includes one or more coupling devices such as a super-conducting coupler.

### Fault Tolerant Logical Operations

Utilizing the L1 logical qubits of respective 2×N arrays as physical qubits requires an ability to manipulate the logical qubits universally. For example, for processor 100 this enables the controller 110 to perform arbitrary quantum operations on each L1 logical qubit stored in arrays 102a, 102b, 102c, 102d. A universal set of operations can be realized through the discrete set:

$$𝒢 = \{ {𝒫}_{Z} , {ℳ}_{Z} , H , T , CNOT \}$$

where [symbol] and [symbol] are preparation and measurement in the Z basis, H and T are single-qubit gates, and CNOT is a two-qubit entangling gate.

Described below are approaches to implement these operations, which are defined analogously on physical spin qubits in silicon quantum dots, on the L1 logical qubits. The ability to achieve accurate universal manipulation of the L1 logical qubits enables the processor 100 treat the L1 qubits as logical qubits, thereby enabling the implementation of a second-level QECC to encode the collective state of a set of M>1 of the L1 logical qubits. In this way, a lower error rate (relative to the spin qubits) of ~10⁻⁴-10⁻⁵ for the L1 logical qubits is reduced to a further lower error rate of ~10⁻¹⁵ for a L2 logical qubit. The L2 logical qubits thereby provide a high-quality qubit with an error rate sufficient for practical quantum computation.

Certain quantum processing operations can be performed in a similar manner across different QECCs, referred to as transversal operations. Transversal operations are operations on the logical qubit which can be realized as a tensor product of operations on the distinct, individual physical qubits of the code:

$${\overline{O}}_{L} = {⊗}_{i = 0}^{n - 1} {O}_{i}$$

where n is the total number of physical qubits. For example, logical X is transversal for all stabilizer codes. For Surface-17, it may be realized by applying

$$\overline{X} = {\overline{O}}_{L} {⊗}_{i = 0}^{8} {O}_{i}$$

at the physical level, where Oᵢ=Xᵢ∀i∈{0,3,6}, and Oᵢ=Iᵢ otherwise (recall, X̅=X₀X₃X₆). Transversal operations are innately fault-tolerant, since single-error events cannot propagate to higher weight errors, due to the disjoint nature of the operation. An implementation of a universal quantum processing operation set with 2×N arrays is described leveraging transversal operations whenever possible.

### Initialization and Measurement

Encoding a logical state with stabilizer codes can be performed by initializing all the data qubits to the appropriate basis, and performing the entangling operations prescribed by the stabilizers of the code. However, instead of entangling data to ancilla qubits, as for the syndrome extraction circuit, data is entangled to data qubits, thereby turning the state of the code into the required entangled logical state (which is in the +1 eigenspace of the stabilizers).

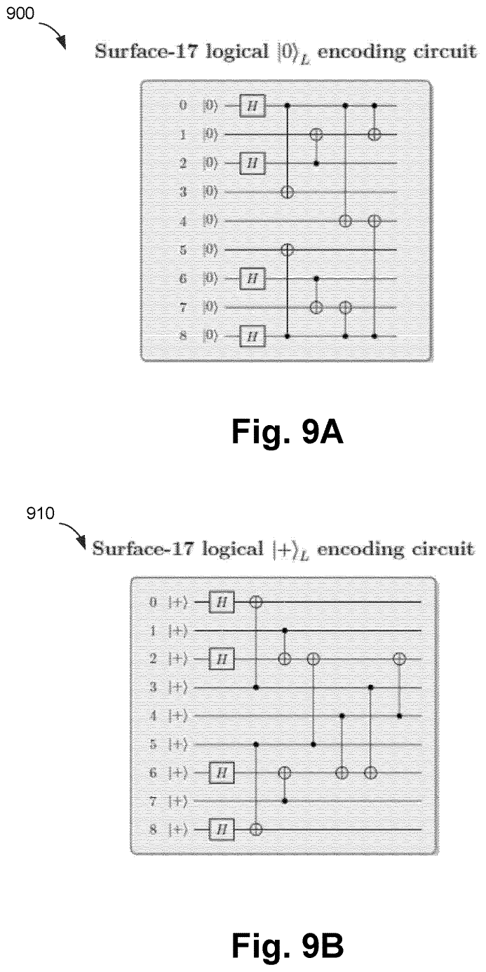

FIGS. 9A and 9B respectively illustrate logical |0 [symbol] and logical |+ [symbol] fault-tolerant logical encoding circuits 900 and 910 to initialize the respective states for the Surface-17 QECC. Note that the entangling operations of both circuits are performed between the data qubits of the code, as it is these qubits that will encode the logical state used for quantum computations.

This type of initialization is general for all stabilizer codes. Note the similarity between preparation (initialization) in the Z basis [symbol] , and in the X basis, [symbol] , the main difference being the initial preparation of the data qubits in either the |0 [symbol] or |+ [symbol] states. For any stabilizer code, measuring the state of the L1 logical qubit can be done [symbol] transversally, by measuring the state of each data qubit. Classical error correction can then be performed to discern the logical state with high probability. Logical measurement in the Z (X) basis, [symbol] ( [symbol] ), requires transversal measurement of the data qubits in the Z (X) basis.

### Single-Qubit Gates: H and T

The H (Hadamard) gate is transversal for some codes, such as the Steane code, but it is not transversal for many other codes. To perform a H gate with other stabilizer codes a code deformation technique may be applied such as braiding around lattice defects (see Fowler [10]) or lattice surgery (see Litinski [11]). Such techniques are applicable to the logical qubits formed by the 2×N arrays, using the methods discussed above to break down the circuits when necessary.

For Surface-17 the H gate is almost transversal. Applying the H gate to all physical qubits leads to the correct logical state (the X and Z logical operators swap), but where the boundaries of the code are switched. In some examples, processor 100 implements the gate by performing a shuttling procedure to rearrange the qubits within the 2×N array so that the boundary qubits restore their natural position. Alternatively, the controller 110 may be configured to keep track of the boundaries that have been switched for all proceeding operations.

One of the most common uses of the H gate is to rotate between the X and Z basis (e.g. for preparing a |+ [symbol] ) state, a |0 [symbol] state may be prepared followed by a H gate). If this is the intended use of H for a particular circuit running an algorithm of interest, then a logical H gate is not needed as logical states in each of the X and Z bases may be initialized and measured directly. In such examples, all that is required is initialization and measurement in both bases, and a H gate, at the physical level (see FIGS. 9A and 9B), which can be achieved with high fidelity with physical spin qubits.

For the surface code, a logical T gate can be achieved using magic state distillation, which involves the use of multiple faulty T gates to produce a single high-quality ‘distilled’ T gate (see Gidney [12]). These distillation protocols require a large number of physical qubits to produce a single high-quality logical T gate.

It will be appreciated that single-qubit gates at the logical level of the codes can be one of the most resource-intensive operations to realize, in terms of the number of extra qubits that they may require. However, single-qubit gates do not necessarily require the qubits to be of high quality. In fact, the noisiest operation which sets the limit on the quality of qubits, below which a QECC can be successfully applied (i.e., the pseudothreshold) is, in general, the CNOT gate.

### Two-Qubit Gate: Logical CNOT

The proposed architecture is able to implement a logical CNOT gate (i.e., between pairs of L1 logical qubits) while maintaining a high pseudothreshold. The CNOT gate implementation is transversal for all codes those whose X and Z stabilizers are composed exclusively out of X and Z operators, respectively (referred to as “CSS codes”), which includes the Surface-17 code.

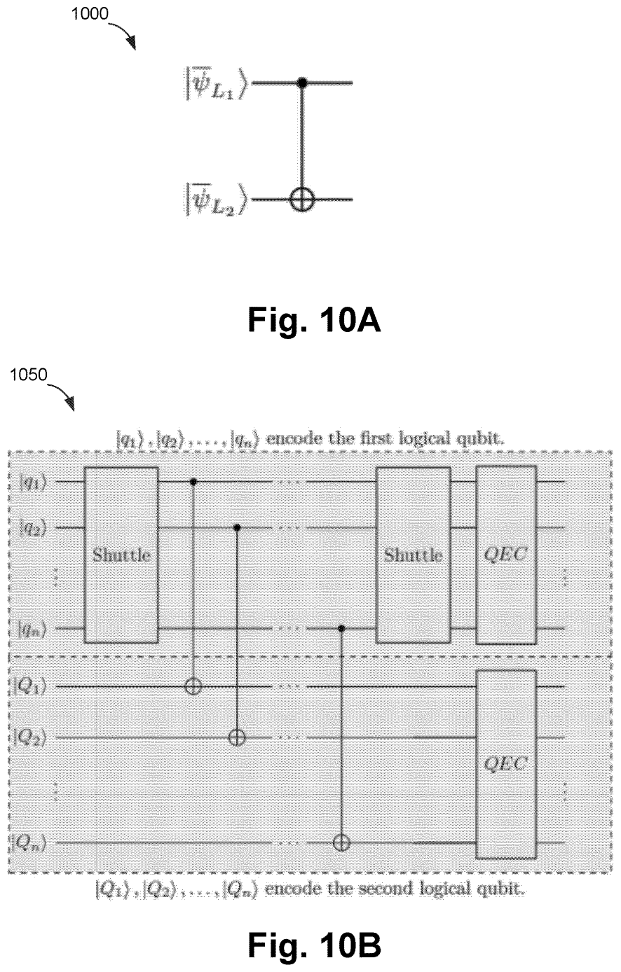

FIGS. 10A and 10B are a pair of circuit diagrams of the logical CNOT gate between two L1 qubits of respectively coupled 2×N modules, at the logical level 1000 and the physical level 1050. The logical qubit state encoded in one of the 2×N modules (control) is |ψ̅_{L}_{₁} [symbol] , and |ψ̅_{L}_{₂} [symbol] is the logical qubit state encoded in the other 2×N module (target). The data qubits of the control 2×N module are |q₁ [symbol] , |q₂ [symbol] , . . . , |qₙ [symbol] , which encode |ψ̅_{L}_{₁} [symbol] , and |Q₁ [symbol] , |Q₂ [symbol] , . . . , |Qₙ [symbol] are the data qubits of the target 2×N module, which encode |ψ̅_{L}_{₂} [symbol] .

Controller 110 is configured to couple first and second L1 logical qubits encoded in two separate 2×N arrays (e.g., 102a with 102c, or 102b with 102d). Coupling a pair of L1 qubits involves performing entangling operations between the spin qubits of each array by: transferring the spin qubits from one array of the pair to the other array of the pair; and performing one or more entangling operations between the transferred spin qubits.

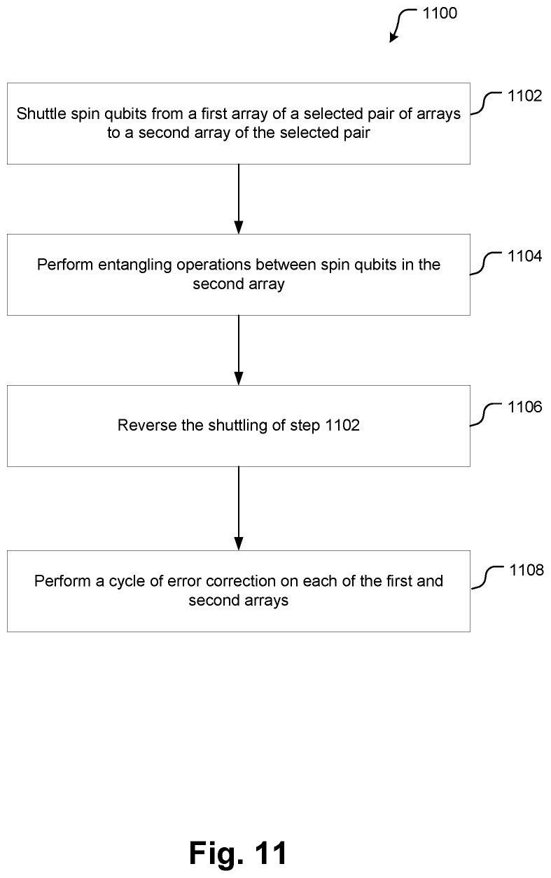

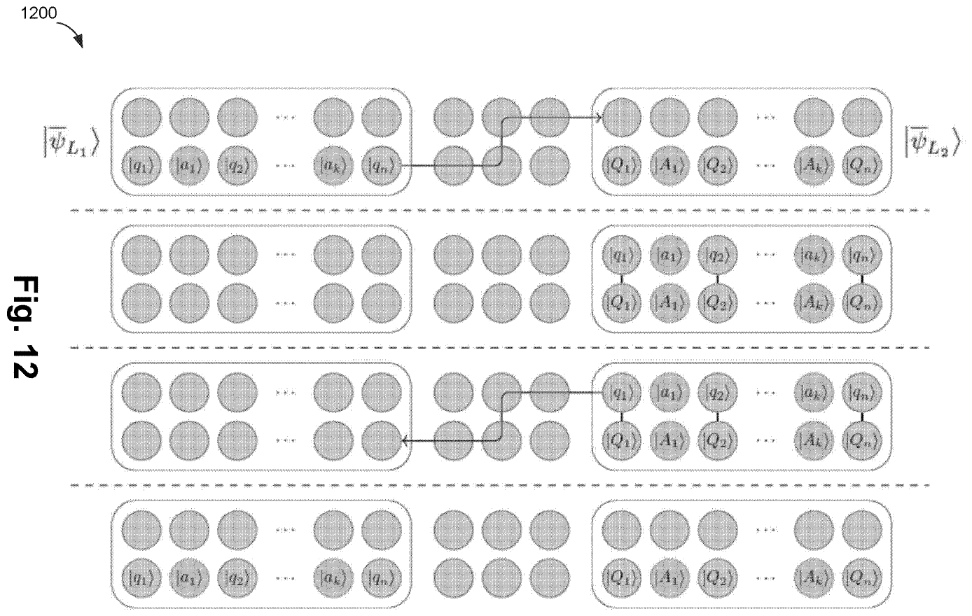

FIG. 11 illustrates a method 1100 performed by the controller 110 to couple (entangle) two logical qubits, encoded in two separate 2×N arrays, such as for example to achieve a fault tolerant CNOT gate between a control array of the plurality of bilinear arrays and a target array of the plurality of bilinear arrays.

At step 1102, the qubits from the control array are shuttled to the second, empty, line of dots of the target array via the shuttling array. At step 1104, a nearest-neighbor CNOT gate is performed between the data qubits within the respective arrays. This generates a logical CNOT gate between the L1 logical qubits encoded in each array. At step 1106, the shuttling process is reversed as the qubits from the second line are shuttled back into the first line of their original array. At step 1108, a cycle of error correction is performed for each of the control and target arrays. This corrects any single-error events which may have occurred during the entire entangling process.

FIG. 12 shows a schematic 1200 illustrating the coherent transportation of underlying spin qubits in the formation of a CNOT gate over a pair of L1 logical qubits, according to method 1100. Note that only the data qubits (labelled |qᵢ [symbol] , |Qᵢ [symbol] ) of each code are entangled since these carry the encoded logical information, while the ancilla qubits (labelled |aᵢ [symbol] , |Aᵢ [symbol] )) are used for the syndrome extraction circuit.

### Evaluation of Two-Qubit Logical Gates

The fidelity of a transversal two qubit gate in generating an entangled logical Bell state using Surface-17 is assessed via simulation. The simulation involved the initialization of the control (target) logical qubit in the logical |0 [symbol] (|+ [symbol] ) state using the encoding circuits of FIG. 9. The two logical qubits are entangled using a CNOT gate, as modelled in FIG. 10. That is, a logical CNOT gate is performed, preceded and proceeded by a round of error correction, according to the experiment. The action of a logical CNOT gate with |+ [symbol] as control, and |0 [symbol] as target is checked against yielding the following logical Bell state

$$\vert {Φ}^{+} {〉}_{L} = \frac{1}{\sqrt{2}} ( \vert 00 {〉}_{L} + \vert 11 {〉}_{L} ) ,$$

$$which is stabalized by {X}_{1} {X}_{2} and {Z}_{1} {Z}_{2} ( {X}_{1} {X}_{2} \vert {Φ}^{+} 〉 = ( + 1 ) \vert {Φ}^{+} 〉 = {Z}_{1} {Z}_{2} \vert {Φ}^{+} 〉 ) .$$

Therefore, if the logical X̅₁X̅₂ and Z̅₁Z̅₂ parity of the final generated state are both trivial (equal to +1) then success is recorded in creating the logical Bell state, otherwise a failure is recorded.

Circuit noise simulations are performed as presented in the evaluation of the L1 logical qubit error rate (discussed above). However, in this simulation errors are modelled at every point of the error correction, including during each operation of the encoding, the error correction rounds performed, and the shuttling of the qubits between different modules.

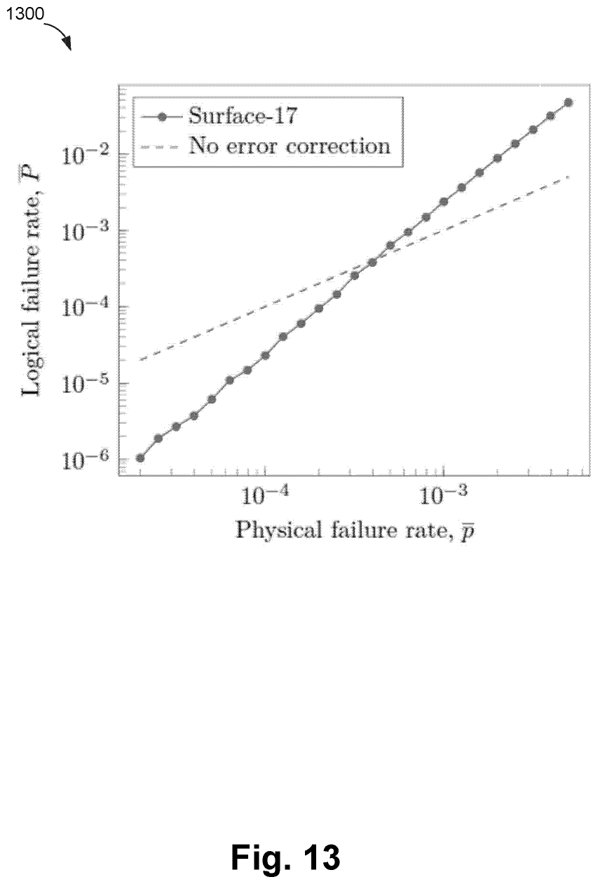

FIG. 13 illustrates a graph 1300 of the failure rate P̅ of the logical |Φ⁺ [symbol] preparation. That is, graph 1300 shows the inaccuracy in the Bell state preparation, which is also known as the infidelity. A pseudothreshold of pₚₜₕ=8.1×10⁻⁴-10⁻³ is observed. That is, if the noise strength on the physical qubits is below this value then more accurate Bell states are prepared for encoded qubits, compared to a Bell state generated from two qubits which were not encoded. The pseudothreshold for logical CNOT using the shuttling error model where errors compound exponentially is 4.5×10⁻⁵.

The results demonstrate a preservation of the strong error correction capabilities of QECCs when performing one of the noisiest operations on the L1 logical qubits stored in the 2×N arrays—the logical CNOT. This verifies that the proposed approaches are useful for providing protection to an idling L1 logical qubit, and also for performing computations with the stored L1 logical qubit, while maintaining the protection.

Scalable Quantum Error Correction with Second-Level Logical Qubits

With reference to FIG. 13, achieving an error rate of ~10⁻⁴ on the physical spin qubits provides a reduced error rate of ~10⁻⁵ in the encoded L1 qubit. Since universal manipulation of the L1 logical qubits stored in the 2×N arrays is possible, the L1 logical qubits can be treated as high-quality qubits with error rates of ~10⁻⁵ on which subsequent error correction can be implemented.

An architecture for quantum processing is proposed in which quantum processor 100 has a plurality of bilinear arrays of quantum dots each of at most N spin qubits, and a controller configured to: (i) control the coherent transportation of one or more of the plurality of qubits within each array to implement a first-level QECC to encode the collective state of the spin qubits of the array as a corresponding first-level (L1) logical qubit; and (ii) selectively couple, via a coherent coupling mechanism, one or more pairs of L1 logical qubits of the plurality of bilinear arrays, to implement a second-level QECC to encode the collective state of a set of M>1 of the L1 logical qubits as a corresponding second-level (L2) logical qubit. The coupling is performed, for a pair of arrays, by long range interaction based transportation of the information encoded by a first L1 qubit of the pair into a second L1 qubit of the pair (e.g., via qubit shuttling over respective shuttling arrays, as described in the examples discussed herein).

This approach advantageously performs two levels of quantum error correction by applying two separate QECCs, such that the first-level QECC reduces an error rate of the (physical) spin qubits to a lower error rate of the L1 logical qubits, and the second-level QECC further reduces the lower error rate of the L1 logical qubits to a further lower error rate of the L2 logical qubit.

A generalized implementation of the proposed two-level quantum error correction approach involves laying down an arbitrary number of sets of M>1 L1 qubits to enable the arrangement of a bigger surface code over the L2 qubits. That is, a surface code with a larger distance than d=3 is applied to protect the L2 qubits. Since a set of M L1 logical qubits have an error rate of ~10⁻⁵, and this is below the threshold value for the surface code family (which is around ~1%), then, a large enough surface code is available to decrease the failure rate of the encoded L2 logical qubit to any desired target.

The proposed approach is advantageous in permitting a selective trade-off between resources (i.e., more qubits) for improved error protection. In particular, the availability of a large enough surface code enables a reduction in the error rate of the encoded L1 logical qubit to ~10⁻¹⁵ which is the required value to execute desirable quantum algorithms.

Further, the proposed two-level approach to qubit error correction can be performed, at least in part, with classical decoding machinery which is practical with current technology. In one example, processor 100 includes a plurality of L2 logical qubits, each of which is generated from a total of M=10000 high-quality (L1) qubits, each of which is in turn composed of N=17 physical qubits.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### REFERENCES

[1] Delfosse, Hierarchical decoding to reduce hardware requirements for quantum computing, 2020, arXiv:2001.11427
[2] Bluvstein, D. et al., “A quantum processor based on coherent transport of entangled atom arrays”, Nature, Vol. 604, 21 Apr. 2022, pp. 451-456.
[3] Mohiyaddin, F. A. et al., “Large-Scale 2D Spin-Based Quantum Processor with a Bi-Linear Architecture”, IEEE International Electron Devices Meeting, 11-15 Dec. 2021, pp. 27.5.1-27.5.4.
[4] J. Yoneda, et al., Nature Communications 12, 10.1038/s41467-021-24371-7 (2021).
[5] Y. Tomita and K. M. Svore, Physical Review A 90, 10.1103/physreva.90.062320 (2014)
[6] D. M. Debroy, M. Li, S. Huang, and K. R. Brown, Logical performance of 9 qubit compass codes in ion traps with crosstalk errors (2020), arXiv:1910.08495.
[7] D. Bacon, Physical Review A 73, 10.1103/physreva.73.012340 (2006).
[8] J. P. Bonilla Ataides, D. K. Tuckett, S. D. Bartlett, S. T. Flammia, and B. J. Brown, Nature Communications 12, 10.1038/s41467-021-22274-1 (2021).
[9] I. Hansen et al. Implementation of the smart protocol for global qubit control in silicon (2021), arXiv:2108.00836.
[10] A. G. Fowler et al., Physical Review A 86, 10.1103/physreva.86.032324 (2012).
[11] D. Litinski, Quantum 3, 128, arXiv:1808.02892v3, (2019).
[12] C. Gidney and A. G. Fowler, Quantum 3, 135, arXiv:1812.01238v3, (2019).

1. A quantum processing device comprising:
at least one bilinear array of quantum dots, each array being configured to hold a plurality of spin qubits; and
a controller configured to control the coherent transportation of one or more of the plurality of qubits within each array to implement a quantum error correction code (QECC), wherein the QECC encodes the collective state of the spin qubits of the respective array as a corresponding first-level (L1) logical qubit.

2. The device of claim 1, wherein each bilinear array comprises: a first line of N quantum dots configured to hold at most N spin qubits; and a second line of N quantum dots configured to enable entangling operations to be performed between respective qubits via the coherent transportation.

3. The device of claim 2, wherein the spin qubits are held in the first line of the array according to an arrangement that is selected to facilitate the coherent transportation of the one or more of the plurality of spin qubits for performing error correction according to the QECC.

4. The device of claim 3, wherein the device is configured to perform a cycle of the error correction on the L1 logical qubit of any one of the at least one bilinear array by: (i) initializing one or more ancilla qubits of the QECC in the array according to the arrangement; (ii) performing one or more 2-qubit entangling gates, each gate entangling one or more pairs of spin qubits of the QECC; and (iii) measuring the ancilla qubits.

5. The device of claim 4, wherein the entangled qubits of the QECC comprise a data qubit associated with a stabilizer of the QECC and one or more corresponding ancilla qubits of the QECC.

6. The device of any of claims 4 to 5, wherein the device is configured to entangle two spin qubits in the array by coherently transporting a selected spin qubit of the pair of spin qubits from the first line of the array through the second line of the array, aligning the selected spin qubit with the other spin qubit, performing a 2-qubit gate, and then coherently transporting at least the selected spin qubit back to the first line of the array.

7. The device of any of claims 4 to 5, wherein the device is configured to entangle two spin qubits in the array by, if the qubits to be entangled already reside in neighbouring dots, causing a direct local interaction between the qubits.

8. The device of any of claims 4 to 7, wherein the one or more 2-qubit entangling gates are scheduled according to the QECC and the geometry of the bilinear array.

9. The device of any of claims 3 to 8, wherein the arrangement of the qubits in the first line of the array is determined to minimize the depth of the syndrome extraction circuit.

10. The device of any of claims 1 to 9, wherein each bilinear array is comprised of silicon metal-oxide semiconductor (SiMOS) quantum dots.

11. The device of any of claims 1 to 10, wherein the QECC is a surface code.

12. A method for enabling quantum error correction on a quantum processing device, the method comprising:
(i) arranging, according to a quantum error correction code (QECC), a plurality of spin qubits in a bilinear array of quantum dots of the quantum processing device, wherein the collective state of a subset of the spin qubits forms a first-level (L1) logical qubit protected by the QECC;
(ii) determining a sequence of one or more entangling operations on respective pairs of the plurality of spin qubits;
(iii) executing a syndrome extraction circuit to determine a syndrome of the QECC for performing a cycle of error correction by performing the sequence of entangling operations,
wherein performing the sequence of entangling operations involves coherently transporting one or more of the plurality of spin qubits within the array.

13. The method of claim 12, wherein the bilinear array comprises: a first line of N quantum dots configured to hold at most N spin qubits; and a second line of N quantum dots configured to enable entangling operations to be performed between respective qubits via the coherent transportation.

14. The method of claim 13, wherein the arrangement of the plurality of spin qubits in the first line is selected to facilitate the coherent transportation of the one or more of the plurality of spin qubits for performing error correction according to the QECC.

15. The method of any of claims 13 to 14, wherein executing the syndrome extraction circuit comprises: (i) initializing one or more ancilla qubits of the QECC in the array according to the arrangement; (ii) performing the determined sequence of entangling operations, each entangling operation entangling a pair of spin qubits of the QECC; and (iii) measuring the ancilla qubits.

16. The method of claim 15, wherein each pair of entangled qubits comprises a data qubit associated with a stabilizer of the QECC and one or more corresponding ancilla qubits of the QECC.

17. The method of any of claims 15 to 16, wherein entangling a pair of spin qubits of the QECC comprises: coherently transporting a selected spin qubit of the pair of spin qubits from the first line of the array through the second line of the array, aligning the selected spin qubit with the other spin qubit of the pair, performing a 2-qubit gate, and then coherently transporting at least the selected spin qubit back to the first line of the array.

18. The method of any of claims 15 to 16, wherein entangling a pair of spin qubits comprises: if the qubits to be entangled already reside in neighbouring dots, causing a direct local interaction between the qubits without coherently transporting either of the qubits.

19. The method of any of claims 12 to 18, wherein the sequence of entangling operations of the syndrome extraction circuit is determined according to the QECC and the geometry of the bilinear array.

20. The method of any of claims 12 to 19, wherein the arrangement of the qubits in the first line of the array is determined to minimize the depth of the syndrome extraction circuit.

21. The method of any of claims 12 to 20, further comprising:
(iv) decoding the syndrome to obtain an output recovery operator; and
(v) applying the recovery operator to the QECC of the array.

22. The method of claim 21, wherein steps (iv) and (v) are performed by a classical processing device, in response to transmission of the syndrome from the quantum processing device to the classical processing device.

23. The device of any of claims 1 to 11, wherein the device comprises a plurality of bilinear arrays of quantum dots, and wherein the controller is further configured to:
selectively couple, via a coherent coupling mechanism, a first L1 logical qubit of a first bilinear array to a second L1 logical qubit of a second bilinear array, wherein the coupling occurs by long range interaction based transportation of the information encoded by the first L1 qubit into the second L1 qubit; and
perform one or more fault tolerant quantum processing operations on the L1 logical qubits of the plurality of bilinear arrays.

24. The device of claim 23, wherein the coherent coupling mechanism includes a quantum transportation structure configured to connect the plurality of bilinear arrays, to enable the controller to selectively couple the first and second L1 logical qubits by the coherent transportation of one or more spin qubits between the first bilinear array and the second bilinear array connected to the first array.

25. The device of claim 24, wherein the quantum transportation structure comprises one or more shuttling arrays of quantum dots, each shuttling array disposed between connected pairs of the bilinear arrays.

26. The device of any of claims 24 to 25, wherein the controller is further configured to couple the first and second L1 logical qubits by creating entangling operations between one or more of the spin qubits of each array of the pair by:
transferring the spin qubits from one array of the pair to the other array of the pair; and
performing one or more entangling operations between the transferred spin qubits.

27. The device of claim 26, wherein the controller is further configured to perform a fault tolerant CNOT gate between a control array of the plurality of bilinear arrays and a target array of the plurality of bilinear arrays by:
coherently transporting the spin qubits from the control array to the target array via the quantum transportation structure;
performing a nearest-neighbour CNOT gate between pairs of one or more of the data qubits of the QECC;
coherently transporting the spin qubits from the target array back into the control array; and
performing a cycle of error correction for each of the control and target arrays.

28. The device of claim 27, wherein the controller is further configured to apply a second-level QECC, to encode the collective state of a set of the L1 logical qubits as a corresponding second-level (L2) logical qubit.

29. The device of claim 28, wherein the distance of the second-level QECC is arbitrarily scalable with a number M>1 of the bilinear arrays of the device.

30. A quantum processing device comprising:
a plurality of bilinear arrays of quantum dots, each array configured to hold a plurality of at most N spin qubits;
a controller configured to:
control the coherent transportation of one or more of the plurality of qubits within each array to implement a first-level QECC to encode the collective state of the spin qubits of the array as a corresponding first-level (L1) logical qubit; and
selectively couple, via a coherent coupling mechanism, one or more pairs of L1 logical qubits of the plurality of bilinear arrays, to implement a second-level QECC to encode the collective state of a set of M>1 of the L1 logical qubits as a corresponding second-level (L2) logical qubit,
wherein the coupling is performed, for each pair, by long range interaction based transportation of the information encoded by a first L1 qubit of the pair into a second L1 qubit of the pair,
such that the first-level QECC reduces an error rate of the spin qubits to a lower error rate of the L1 logical qubits, and the second-level QECC further reduces the lower error rate of the L1 logical qubits to a further lower error rate of the L2 logical qubit.

31. The device of claim 30, wherein the coherent coupling mechanism includes a quantum transportation structure configured to connect the plurality of bilinear arrays, to enable the controller to selectively couple the one or more pairs of L1 logical qubits by, for each pair, coherent transportation of one or more spin qubits between a first array of the pair, and a second array of the pair connected to the first array.

32. The device of claims 30 to 31, wherein the controller is further configured to perform a set of fault tolerant quantum processing operations with one or more L2 logical qubits of the device.

33. A method for performing a fault tolerant quantum processing operation, the method executed by the quantum processing device of claim 32, the method comprising:
determining at least two connected bilinear arrays to perform a quantum processing operation;
selecting one or more pairs of the determined connected bilinear arrays, and for each selected pair including a first array and a second array:
(i) coherently transporting at least a subset of the spin qubits from the first array to the second array;
(ii) performing individual entangling operations between the spin qubits within the second array;
(iii) reversing the coherent transportation of step (i); and
(iv) performing a cycle of error correction on each of the first and second arrays, wherein the cycle of error correction is enabled by the method of any of claims 12 to 22.
